(19) United States
(12) Patent Application Publication
(10) Pub. No.: US 2016/0240905 A1
(43) Pub. Date: Aug. 18, 2016

(54) HYBRID FOLDED RECTANGULAR WAVEGUIDE FILTER

(71) Applicant: ESA EUROPEAN SPACE AGENCY, Paris Cedex 15 (FR)

(72) Inventor: Marco GUGLIELMI, Wassenaar (NL)

(73) Assignee: EUROPEAN SPACE AGENCY, Paris (FR)

(21) Appl. No.: 15/025,433

(22) PCT Filed: Oct. 25, 2013
(86) PCT No.: PCT/EP2013/072406

§ 371 Date: Mar. 28, 2016

(51) Int. Cl. H01P 1/207; H01P 5/02; H01P 7/06

(52) U.S. Cl. CPC H01P 1/207; H01P 7/06; H01P 5/02

(57) ABSTRACT

A group of rectangular waveguide resonators include first and second resonators that are arranged so that first lateral walls of the first resonator extend in parallel to second lateral walls of the second resonator. The first lateral walls correspond to broad sides of a first cross section of the first resonator perpendicular to a guide direction of the first resonator. The second lateral walls correspond to broad sides of a second cross section of the second resonator perpendicular to a guide direction of the second resonator. The first and second resonators are further arranged so that one of the first lateral walls at least partially faces one of the second lateral walls, and the first resonator is electromagnetically coupled to the second resonator through a first aperture in the one of the first lateral walls and a second aperture in the one of the second lateral walls.

### TECHNICAL FIELD OF THE INVENTION

The present invention relates to a group of resonators in rectangular waveguide (rectangular waveguide resonators) for use in a rectangular waveguide filter and to a rectangular waveguide filter employing the group of rectangular waveguide resonators.

The invention is particularly though not exclusively applicable to microwave filters in the front end of ground and satellite payloads for e.g. telecommunication, radar, Synthetic Aperture Radar (SAR), radiometers, radiolinks, etc.

### BACKGROUND OF THE INVENTION

Microwave filters consisting of sections of rectangular waveguide (also referred to as microwave filters in rectangular waveguide) have been known for more than 50 years. In the most basic “in-line” implementation of such a microwave filter, as illustrated e.g. in FIG. 14, rectangular cavity resonators 1410, i.e. sections of rectangular waveguide having a length corresponding to half a wavelength, are coupled to each other with small sections 1470 of rectangular waveguide below cut-off (inductive coupling windows) located in the input-output walls of each resonator. A discussion of such microwave filters, which are commonly used in the front end of many different types of payloads, including telecommunication, radars, SAR, radiometers, radiolinks, etc. is provided in M. Guglielmi, A. Melcon, Novel Design Procedure for Microwave Filters, Proceedings of the 23^{rd} European Microwave Conference, 1993.

For all payloads a reduction in size, and in particular a reduction of the so-called “footprint”, which is the area occupied by the filter when seen in projection on a mounting surface, is a very important issue. This is especially the case for mobile applications and space applications, in which the available area of mounting space is severely limited and oftentimes has to be shared by multiple components.

Moreover, in many of the technical applications in which microwave filters are commonly used, there is the desire for being able to implement more complex transfer functions that go beyond standard Chebyshev transfer functions, such as transfer functions displaying phase equalization or transmission zeros at finite frequency. Such more complex transfer functions are discussed in R. Cameron, Advanced Filter Synthesis, IEEE Microwave Magazine, October 2011. However, microwave filters consisting of sections of rectangular waveguide as discussed above do not allow for the implementation of couplings between non-adjacent resonators (i.e. non-adjacent along the RF-path) because of their in-line structure. In consequence, such microwave filters do not allow for the implementation of the desired more complex transfer functions.

The latter issue has been addressed in the prior art by providing more complex filter designs. In J. R. Montejo-Garai, J. A. Ruiz-Cruz, J. M. Rebollar, M. J. Padilla-Cruz, A. Onoro-Navarro, I. Hidalgo-Carpintero, Synthesis and Design of In-Line N-Order Filters with N Real Transmission Zeros by Means of Extracted Poles Implemented in Low-Cost Rectangular H-Plane Waveguide, IEEE Transactions on Microwave Theory and Techniques, Vol. 53, No. 5, May 2005, additional resonators are added to the microwave filter, while a microwave filter structure is folded in the horizontal plane in J. A. Ruiz-Cruz, K. A. Zaki, J. R. Montejo-Garai, J. M. Rebollar, Rectangular Waveguide Elliptic Filters with Capacitive and Inductive Irises and Integrated Coaxial Excitation, International Microwave Symposium Digest, 2005 IEEE MTT-S.

Although both of the above approaches prove to be effective in implementing more complex transfer functions, they clearly fail in reducing the footprint of the filter. In fact, by adding additional resonators or by folding the filter structure in the horizontal plane, the above approaches undertaken in the prior art even tend to increase the footprint of the resulting microwave filter.

Moreover, microwave filters designed in accordance with the above prior art approaches may not be manufactured using the so-called clam-shell approach, according to which two matching halves are joined together to form the microwave filter. This configuration is particularly convenient from an electrical performance point of view because the surface defined by the mating of the two halves is not cut by any electrical current. Furthermore, the clam-shell approach enables particularly simple and inexpensive manufacture of microwave filters. As a consequence there is the additional problem in the prior art that manufacturing of filters that implement more complex transfer functions is comparably difficult and expensive.

Summarizing, at present there is no viable approach to providing a microwave rectangular waveguide filter that would allow for the implementation of more complex transfer functions and at the same time has a reduced footprint and can be manufactured in a simple manner.

### SUMMARY OF THE INVENTION

It is an object of the present invention to overcome the limitations of the prior art discussed above. It is another object of the invention to provide a rectangular waveguide filter with reduced size and reduced footprint. It is yet another object of the invention to provide a rectangular waveguide filter that allows for the implementation of more complex transfer functions beyond the standard Chebyshev transfer functions. It is yet another object of the invention to provide a rectangular waveguide filter that may be manufactured in a simple and inexpensive manner.

In view of the above objects, the present invention proposes a group of rectangular waveguide resonators and a rectangular waveguide filter comprising the group of rectangular waveguide resonators having the features of the respective independent claims. Preferred embodiments of the invention are described in the dependent claims.

In the below summary of aspects of the present invention, it is understood that a resonator in rectangular waveguide has a guide direction which defines a longitudinal direction of the resonator. Conventionally, the z-axis of a coordinate system used to describe the resonator is defined to extend along the longitudinal direction of the resonator. Further, the (transverse) cross section of the resonator perpendicular to the longitudinal direction of the resonator is referred to simply as the cross section of the resonator. An axis extending along the longitudinal direction and intersecting the cross section in its center is referred to as the central axis of the resonator. Walls of the resonator that extend in parallel to the longitudinal direction of the resonator are referred to as the lateral walls of the resonator, and walls that are perpendicular to the longitudinal direction are referred to as end walls. Lateral walls of the resonator that correspond to broad sides (i.e. longer sides) of the cross section are referred to as broad walls, or the top wall and the bottom wall of the resonator. Conventionally, the x-axis of the coordinate system is defined to extend in parallel to the broad sides of the cross section. In other words, the broad walls extend in a plane (referred to as the horizontal plane) spanned by the x-axis and the z-axis. Lateral walls of the resonator that correspond to narrow sides (i.e. shorter sides) of the cross section are referred to as narrow walls, or the side walls of the resonator. Conventionally, the y-axis of the coordinate system is defined to extend in parallel to the narrow sides of the cross section. In other words, the narrow walls extend in a plane spanned by the y-axis and the z-axis. Further, a width direction of the resonator is said to extend in parallel to the broad sides of the cross section (i.e. along the x-axis), and a height direction of the resonator is said to extend in parallel to the narrow sides of the cross section (i.e. along the y-axis). In the resonator as defined above, the electric field component E_{y} of the TE101 (TE₁₀₁) resonant mode is oriented along the height direction, while the magnetic field component Hz of the TE101 resonant mode is oriented along the guide direction, and the HX component of the magnetic field of the TE101 resonant mode is oriented along the width direction. Of course, in all filters described below, in addition to the TE101 mode all modes of a rectangular waveguide resonator, namely TEᵢₘₙ and TMᵢₘₙ, where i, m, n are integers, can be used as well, if found convenient or desirable.

According to an aspect of the invention, a group of rectangular waveguide resonators for use in a rectangular waveguide filter is provided, the group comprising a first resonator and a second resonator, wherein the first and second resonators are arranged so that first lateral walls of the first resonator extend in parallel to second lateral walls of the second resonator, the first lateral walls corresponding to broad sides (longer sides) of a first cross section of the first resonator perpendicular to a guide direction of the first resonator and the second lateral walls corresponding to broad sides (longer sides) of a second cross section of the second resonator perpendicular to a guide direction of the second resonator, the first and second resonators are further arranged so that one of the first lateral walls at least partially faces one of the second lateral walls, and the first resonator is electromagnetically coupled to the second resonator through a first aperture in the one of the first lateral walls and a second aperture in the one of the second lateral walls.

According to the above configuration, the first and second resonators are arranged so that they at least partially overlap when seen in projection on a mounting surface which extends in parallel to the first lateral walls of the first resonator (i.e. the top and bottom walls, or the broad walls of the first resonator). Since the first and second resonators are overlapping, a length of the group of resonators is reduced. Thus, by employing the inventive group of resonators in a microwave filter, the footprint of the microwave filter can be reduced.

Moreover, in the inventive group of rectangular waveguide resonators the second resonator is arranged away from a horizontal plane in which the first resonator is arranged. As a consequence, a third resonator can be arranged next to (i.e. below) the second resonator along the central axis of the first resonator, so that the cross section of the third resonator is aligned with the cross section of the first resonator. The third resonator can then be electromagnetically coupled to the first resonator through apertures in the end walls of the first and third resonators. Accordingly, the present invention enables electromagnetic coupling between non-adjacent resonators (i.e. non-adjacent along the RF-path; here the first resonator and the third resonator are non-adjacent along the RF-path, assuming that the third resonator is also coupled to the second resonator), and non-standard transfer functions can be implemented without having to fold the microwave filter in the horizontal plane, i.e. without increasing the footprint of the microwave filter.

Lastly, by virtue of the inventive configuration, a microwave filter can be provided that implements a non-standard transfer function and that is at the same time symmetric with respect to a symmetry plane extending along the guide direction and the height direction of the first resonator (i.e. extending in parallel to the narrow walls of the first resonators, or along the z-axis and the y-axis). Such a microwave filter, due to its symmetry, can be manufactured by the clam-shell approach in which matching halves are manufactured and machined separately, and subsequently joined to form the microwave filter. Accordingly, a microwave filter employing the inventive group of rectangular waveguide resonators can be manufactured in a particularly simple and inexpensive manner.

Preferably, the first aperture and the second aperture have identical shape and the first and second resonators are further arranged so that the first and second apertures fall in line with each other. Further preferably, the first aperture has the shape of a rectangle extending over the full width of the first cross section in a width direction of the first resonator, and the second aperture has the shape of a rectangle extending over the full width of the second cross section in a width direction of the second resonator, the width direction of the first resonator being defined by the broad sides of the first cross section and the width direction of the second resonator being defined by the broad sides of the second cross section.

The first and second resonators may be further arranged so that the guide direction of the first resonator extends in parallel to the guide direction of the second resonator, lateral walls of the first resonator other than the first lateral walls extend in parallel to lateral walls of the second resonator Other than the second lateral walls, and the second resonator is shifted with respect to the first resonator in the guide direction of the first resonator.

In a preferred embodiment, the group of rectangular waveguide resonators further comprises a third resonator, wherein the third resonator is arranged so that a guide direction of the third resonator is aligned with the guide direction of the first resonator and the first cross section is aligned with a third cross section of the third resonator perpendicular to the guide direction of the third resonator (one of end walls of the first resonator faces one of end walls of the third resonator), and the third resonator is electromagnetically coupled to the second resonator. In particular, the third resonator may be further arranged so that one of third lateral walls of the third resonator at least partially faces the one of the second lateral walls, the third lateral walls corresponding to broad sides of the third cross section, and the second resonator is electromagnetically coupled to the third resonator through a third aperture in the one of the second lateral walls, the third aperture being distinct from the second aperture, and a fourth aperture in the one of the third lateral walls.

By the above inventive configuration, a third order filter (three pole filter) can be provided that is significantly shorter than a conventional three pole filter and that has significantly smaller footprint than the conventional three pole filter. Moreover, the above group of resonators is symmetric with respect to a symmetry plane extending along the width direction and the height direction, such that the group of resonators can be manufactured using the clam-shell approach, which enables particularly simple and inexpensive manufacture.

A particular advantage is achieved if the first resonator is electro-magnetically coupled to the third resonator through opposing apertures in the one of the end walls of the first resonator and the one of the end walls of the third resonator. Therein, the first resonator may be electromagnetically coupled to the third resonator through a ridge resonator interposed between the one of the end walls of the first resonator and the one of the end walls of the third resonator. Alternatively, the first resonator may be electromagnetically coupled to the third resonator through an inductive coupling section interposed between the one of the end walls of the first resonator and the one of the end walls of the third resonator, or through a hybrid coupling section interposed between the one of the end walls of the first resonator and the one of the end walls of the third resonator. Further, a first electrical length of the first resonator in the guide direction of the first resonator may be equal to half of a second electrical length of the second resonator in the guide direction of the second resonator and equal to a third electrical length of the third resonator in the guide direction of the third resonator.

By the above inventive configuration, a three pole filter with a non-standard transfer function can be provided that is significantly shorter than a comparable conventional filter, and that has significantly smaller footprint than the conventional filter. Depending on the choice of the coupling section interposed between coupling apertures in the one of the end walls of the first resonator and the one of the end walls of the third resonator, the transfer function of a filter employing the group of resonators features a transmission zero above or below the pass-band. For instance, for an inductive coupling section, and using a TE101 resonant mode for the first, second, and third resonators, a transmission zero of the transfer function above the pass-band of the filter is achieved. On the other hand, a transmission zero of the transfer function below the pass-band of the filter is achieved if a TE102 (TE₁₀₂) resonant mode is used for the second resonator and a TE101 resonant mode is used for the first resonator and the third resonator, respectively, since in this case the coupling between the first resonator and the third resonator becomes negative. Employing a ridge resonator as the coupling section, the transmission zero of the transfer function can be tuned to lie below or above the pass-band of the filter by adjusting the design parameters of the ridge resonator (i.e. a capacitance of a capacitive section of the ridge resonator and an inductance of an inductive section of the ridge resonator). Moreover, the above group of resonators is symmetric with respect to a symmetry plane extending along the guide direction and the height direction (i.e. extending in parallel to the narrow walls of the first resonator, or along the z-axis and the y-axis), such that the group of resonators can be manufactured using the clam-shell approach, which enables particularly simple and inexpensive manufacture.

In a further preferred embodiment, the group of rectangular waveguide resonators further comprises a third resonator and a fourth resonator, wherein the third resonator is arranged so that a guide direction of the third resonator is aligned with the guide direction of the second resonator and the second cross section is aligned with a third cross section of the third resonator perpendicular to the guide direction of the third resonator (one of end walls of the third resonator faces one of end walls of the second resonator), the fourth resonator is arranged so that a guide direction of the fourth resonator is aligned with the guide direction of the first resonator and the first cross section is aligned with a fourth cross section of the fourth resonator perpendicular to the guide direction of the fourth resonator (one of end walls of the first resonator faces one of end walls of the fourth resonator), the third and fourth resonators are further arranged so that third lateral walls of the third resonator extend in parallel to fourth lateral walls of the fourth resonator, the third lateral walls corresponding to broad sides of the third cross section and the fourth lateral walls corresponding to broad sides of the fourth cross section, the third and fourth resonators are further arranged so that one of the third lateral walls at least partially faces one of the fourth lateral walls, the second resonator is electromagnetically coupled to the third resonator through opposing apertures in one of end walls of the second resonator and one of end walls of the third resonator, and the third resonator is electromagnetically coupled to the fourth resonator through a third aperture in the one of the third lateral walls and a fourth aperture in the one of the fourth lateral walls.

By the above inventive configuration, a fourth order filter (four pole filter) can be provided that is significantly shorter than a conventional four pole filter and that has significantly smaller footprint than the conventional four pole filter. Moreover, the above group of resonators is symmetric with respect to a symmetry plane extending along the guide direction and the height direction (i.e. extending in parallel to the narrow walls of the first resonator, or along the z-axis and the y-axis), such that the group of resonators can be manufactured using the clam-shell approach, which enables particularly simple and inexpensive manufacture.

A particular advantage is achieved if the first resonator is electromagnetically coupled to the fourth resonator through opposing apertures in the one of the end walls of the first resonator and the one of the end walls of the fourth resonator. Therein, the first resonator may be electromagnetically coupled to the fourth resonator through a ridge resonator interposed between the one of the end walls of the first resonator and the one of the end walls of the fourth resonator. Alternatively, the first resonator may be electromagnetically coupled to the fourth resonator through an inductive coupling section interposed between the one of the end walls of the first resonator and the one of the end walls of the fourth resonator.

By the above inventive configuration, a four pole filter with a non-standard transfer function can be provided that is significantly shorter than a comparable conventional filter and that has significantly smaller footprint than the conventional filter. Depending on the choice of the coupling section interposed between the one of the end faces of the first resonator and the one of the end faces of the fourth resonator, the transfer function of a filter employing the group of resonators features a transmission zero above and below the pass-band, or phase equalization. For instance, employing the ridge resonator for coupling the first and fourth resonators results in a transmission zero below the pass-band of the filter and a transmission zero above the pass-band. By employing the inductive coupling section and appropriately tuning the width of the inductive coupling section, which is decisive for a strength of the electromagnetic coupling between the first and fourth resonators, phase equalization of the transfer function is achieved. Moreover, the above group of resonators is symmetric with respect to a symmetry plane extending along the guide direction and the height direction (i.e. extending in parallel to the narrow walls of the first resonator, or along the z-axis and the y-axis), such that the group of resonators can be manufactured using the clam-shell approach, which enables particularly simple and inexpensive manufacture.

In a further preferred embodiment, the group of rectangular waveguide resonators further comprises a third resonator, wherein the third resonator is arranged so that third lateral walls of the third resonator extend in parallel to the first lateral walls, the third lateral walls corresponding to broad sides of a third cross section of the third resonator perpendicular to a guide direction of the third resonator, the third resonator is further arranged so that one of the third lateral walls at least partially faces the other one of the first lateral walls, and the first resonator is electromagnetically coupled to the third resonator through a third aperture in the other one of the first lateral walls and a fourth aperture in the one of the third lateral walls.

In a yet further preferred embodiment, the group of rectangular waveguide resonators further comprises a third resonator and a fourth resonator, wherein the third resonator is arranged so that a guide direction of the third resonator is aligned with the guide direction of the first resonator, the first resonator is electromagnetically coupled to the third resonator, the fourth resonator is arranged so that third lateral walls of the third resonator extend in parallel to fourth lateral walls of the fourth resonator, the third lateral walls corresponding to broad sides of a third cross section of the third resonator perpendicular to the guide direction of the third resonator and the fourth lateral walls corresponding to broad sides of a fourth cross section of the fourth resonator perpendicular to the guide direction of the fourth resonator, the third and fourth resonators are further arranged so that one of the third lateral walls at least partially faces one of the fourth lateral walls, the third resonator is electromagnetically coupled to the fourth resonator through a third aperture in the one of the third lateral walls and a fourth aperture in the one of the fourth lateral walls, and the second resonator and the fourth resonator are arranged on opposite sides of a central axis of the first resonator extending along the guide direction of the first resonator.

By the above inventive configurations, microwave filters having customized transfer functions beyond the standard. Chebyshev transfer functions can be provided that are significantly shorter and have a significantly smaller footprint than conventional filters with comparable electrical performances. Moreover, the above groups of resonators are symmetric with respect to a symmetry plane extending along the guide direction and the height direction (i.e. extending in parallel to the narrow walls of the first resonator, or along the z-axis and the y-axis), such that the groups of resonators can be manufactured using the clam-shell approach, which enables particularly simple and inexpensive manufacture of the resulting microwave filters.

According to another aspect of the invention, a rectangular waveguide filter comprising the group of rectangular waveguide resonators is provided.

### BRIEF DESCRIPTION OF THE FIGURES

FIG. 1A is a perspective view of a rectangular waveguide filter according to a first embodiment of the invention;

FIG. 1B is a sagittal cut through the filter of the first embodiment;

FIG. 1C is a transverse cut through the filter of the first embodiment;

FIG. 1D is a horizontal cut through the filter of the first embodiment;

FIG. 1E illustrates an electrical performance of the filter of the first embodiment;

FIG. 2A is a perspective view of a rectangular waveguide filter according to a second embodiment of the invention;

FIG. 2B is sagittal cut through the filter of the second embodiment;

FIG. 2C illustrates an electrical performance of the filter of the second embodiment;

FIG. 3A is a perspective view of a rectangular waveguide filter according to a third embodiment of the invention;

FIG. 3B is a sagittal cut through the filter of the third embodiment;

FIG. 3C illustrates an electrical performance of the filter of the third embodiment;

FIG. 4A is a perspective view of a rectangular waveguide filter according to a fourth embodiment of the invention;

FIG. 4B is a sagittal cut through the filter of the fourth embodiment;

FIG. 4C illustrates an electrical performance of the filter of the fourth embodiment;

FIG. 5A is a perspective view of a rectangular waveguide filter according to a fifth embodiment of the invention;

FIG. 5B is a sagittal cut through the filter of the fifth embodiment;

FIG. 5C illustrates an electrical performance of the filter of the fifth embodiment;

FIG. 6A is a perspective view of a ridge resonator structure;

FIG. 6B is a horizontal cut through the ridge resonator structure;

FIG. 6C is a sagittal cut through the ridge resonator structure;

FIGS. 6D and 6E illustrate an electrical performance of the ridge resonator structure;

FIG. 7A is a perspective view of a rectangular waveguide filter according to a sixth embodiment of the invention;

FIG. 7B is a sagittal cut through the filter of the sixth embodiment;

FIG. 7C illustrates an electrical performance of the filter of the sixth embodiment;

FIG. 8A is a perspective view of a rectangular waveguide filter according to a seventh embodiment of the invention;

FIG. 8B is a sagittal cut through the filter of the seventh embodiment;

FIG. 8C illustrates an electrical performance of the filter of the seventh embodiment;

FIG. 9A is a perspective view of a rectangular waveguide filter according to an eighth embodiment of the invention;

FIG. 9B is a sagittal cut through the filter of the eighth embodiment;

FIG. 9C illustrates an electrical performance of the filter of the eighth embodiment;

FIG. 10A is a perspective view of a rectangular waveguide filter according to a ninth embodiment of the invention;

FIG. 10B is a sagittal cut through the filter of the ninth embodiment;

FIG. 10C is a first horizontal cut through the filter of the ninth embodiment;

FIG. 10D is a second horizontal cut through the filter of the ninth embodiment;

FIG. 10E illustrates an electrical performance of the filter of the ninth embodiment;

FIG. 11A is a perspective view of a rectangular waveguide filter according to a tenth embodiment;

FIG. 11B is a sagittal cut through the filter of the tenth embodiment;

FIG. 11C illustrates an electrical performance of the filter of the tenth embodiment;

FIG. 12A is a perspective view of a rectangular waveguide filter according to an eleventh embodiment;

FIG. 12B is a sagittal cut through the filter of the eleventh embodiment;

FIG. 12C illustrates an electrical performance of the filter of the eleventh embodiment;

FIG. 13A is a perspective view of a six channel manifold multiplexer according to a twelfth embodiment;

FIG. 13B is a sagittal cut through the multiplexer of the twelfth embodiment;

FIG. 13C illustrates an electrical performance of the multiplexer of the twelfth embodiment;

FIG. 14A is a perspective view of a fourth order rectangular waveguide filter according to the prior art;

FIG. 14B is a sagittal cut through the filter of FIG. 14A;

FIG. 14C is a horizontal cut through the filter of FIG. 14A;

FIG. 14D illustrates an electrical performance of the filter of FIG. 14A;

FIG. 15A is a perspective view of a third order rectangular waveguide filter according to the prior art;

FIG. 15B is a sagittal cut through the filter of FIG. 15A;

FIG. 15C is a horizontal cut through the filter of FIG. 15A; and

FIG. 15D illustrates an electrical performance of the filter of FIG. 15A.

### DETAILED DESCRIPTION OF THE INVENTION

Preferred embodiments of the present invention will be described in the following with reference to the accompanying figures, wherein in the figures identical objects are indicated by identical reference numbers. It is understood that the present invention shall not be limited to the described embodiments, and that the described features and aspects of the embodiments may be modified or combined to form further embodiments of the present invention.

In the following detailed description of the invention, it will be referred to microwave filters. Therein, the term microwave filter is considered to indicate a filter suitable for filtering electromagnetic radiation having a frequency range for which use of a rectangular waveguide is appropriate.

Moreover, in the figures discussed in the following, the views of waveguide filters relate to an RF-path view, i.e. only the confining faces of the electromagnetic field inside the filters are shown. That is, the actual physical walls of the filters are not shown in the figures. However, it is understood that for each confining face a corresponding wall is present.

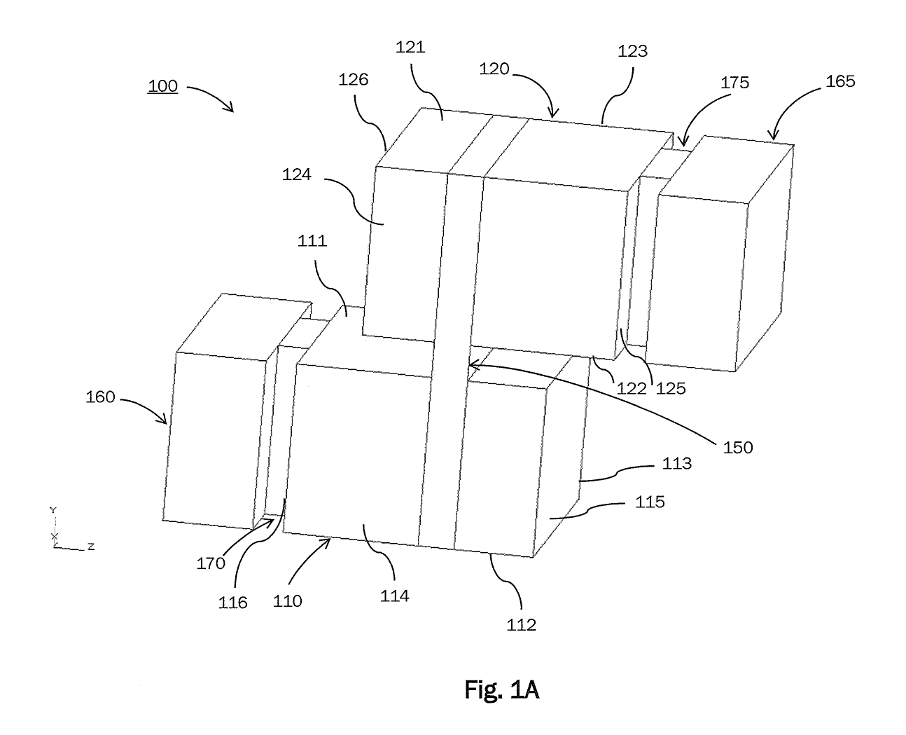

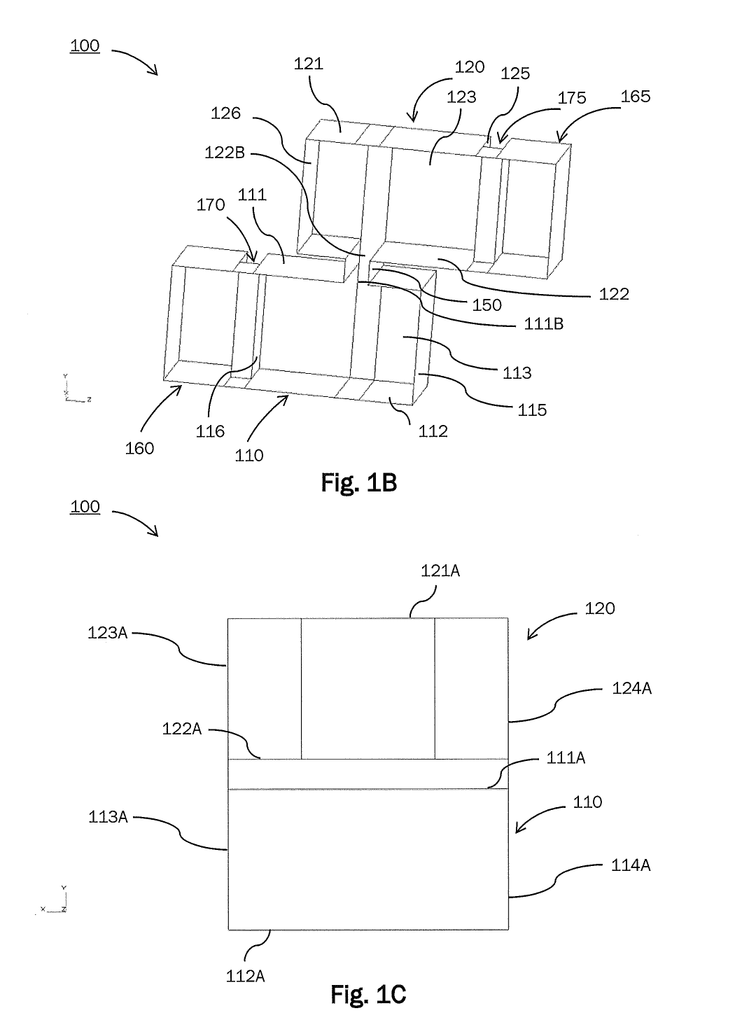

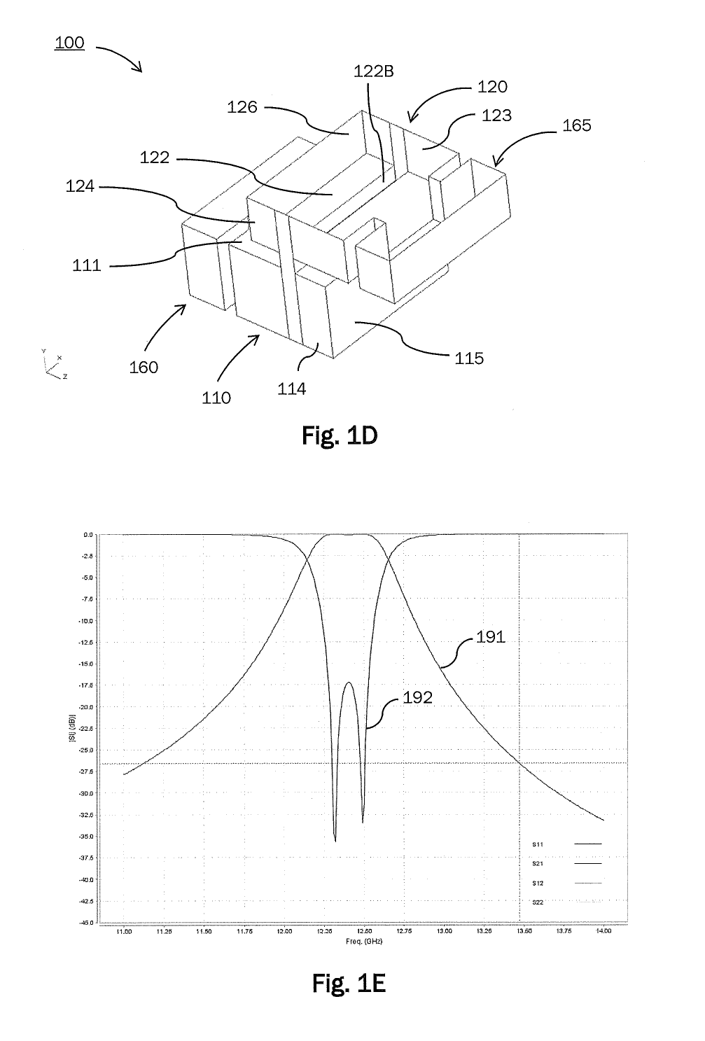

First, a rectangular waveguide filter 100 according to a first embodiment of the invention will be described with reference to FIGS. 1A to 1E. FIG. 1A is a perspective view of the rectangular waveguide filter 100 according to the first embodiment of the invention, FIG. 1B is a sagittal cut (i.e. a cut along the y-z-plane) through the rectangular waveguide filter 100, FIG. 1C is a transverse cut (i.e. a cut along the x-y-plane) through the rectangular waveguide filter 100, FIG. 1D is a horizontal cut (i.e. a cut along the x-z-plane) the rectangular waveguide filter 100, and FIG. 1E illustrates the electrical performance of the rectangular waveguide filter 100.

The rectangular waveguide filter 100 comprises a group of resonators of a first resonator 110 and a second resonator 120, each of which is a rectangular waveguide resonator (a resonator formed by a section of rectangular waveguide, or a resonator in rectangular waveguide), interposed between an input port 160 and an output port 165. The first resonator 110 is coupled to the input port 160 through a first coupling section 170, and the second resonator 120 is coupled to the output port 175 through a second coupling section 175. Exemplarily, inductive coupling sections (inductive coupling windows or inductive coupling irises) are illustrated as the first and second coupling sections 170, 175. However, instead of inductive coupling sections, also alternative coupling sections that are readily apparent to the expert of skill in the art can be used for coupling the first and second resonators 110, 120 to the input and output ports 160, 165, respectively, e.g. capacitive coupling sections (capacitive coupling windows or capacitive coupling irises) or hybrid coupling sections (hybrid coupling windows or hybrid coupling irises).

An inductive coupling section is understood as a coupling section having a rectangular cross section with a width of the cross section that is smaller than the width of the rectangular waveguide resonators that are coupled to each other by the inductive coupling section. The height of the cross section is equal to the height of the rectangular waveguide resonators. A capacitive coupling section is understood as a coupling section having a rectangular cross section with a height of the cross section that is smaller than the height of the rectangular waveguide resonators that are coupled to each other by the capacitive coupling section. The width of the cross section is equal to the width of the rectangular waveguide resonators. A hybrid coupling section is understood as a coupling section having a rectangular cross section with a width of the cross section that is smaller than the width of the rectangular waveguide resonators that are coupled to each other by the hybrid coupling section, and a height of the cross section that is smaller than the height of the rectangular waveguide resonators.

In the above, it is understood that the term “coupling” refers to electromagnetic coupling. Electromagnetic coupling of two resonators is understood to indicate a situation in which electromagnetic fields present in the two resonators can influence each other, i.e. an electromagnetic field can spread over both resonators.

Now, referring to FIGS. 1A to 1D, directions with respect to a resonator of rectangular waveguide will be defined that shall be valid for all resonators throughout the remainder of the description of the present invention. A guide direction (or longitudinal direction) of the resonator is understood to be a direction defined by the longitudinal direction of the section of waveguide forming the respective resonator. In other words, the guide direction of the resonator extends in parallel to the Hz-component of the TE101 mode of the resonator. For instance, in FIG. 1C, the guide directions of the first and second resonators 110, 120 extend in perpendicular to the paper plane.

FIG. 1C illustrates a transverse cut though the rectangular waveguide filter 100 (i.e. a cut perpendicular to the guide directions of the first and second resonators 110, 120). In this figure, the upper rectangle represents the cross section of the second resonator 120 and the lower rectangle represents the cross section of the first resonator 110. The view of FIG. 1C is from the left in FIG. 1A. Vertical lines in the upper rectangle represent a coupling aperture through which the second resonator 120 is coupled to an output port.

A width direction of the resonator is perpendicular to the guide direction and is defined by the two broad ones (i.e. longer ones) of the four sides of a cross section of the resonator perpendicular to the guide direction (i.e. the transverse cross section, henceforth referred to simply as the cross-section). For instance, in FIG. 1C, sides 111A, 112A of the cross section of the first resonator 110 define a width direction of the first resonator 110 and sides 121A, 122A of the cross section of the second resonator 120 define a width direction of the second resonator 120.

A height direction of the resonator is perpendicular to the guide direction and to the width direction and is defined by the two narrow ones (i.e. shorter ones) of the four sides of the cross section. In other words, the height direction extends in parallel to the E_{y}-component of the TE101 mode of the resonator. For instance, in FIG. 1C, sides 113A, 114A of the cross section of the first resonator 110 define a height direction of the first resonator 110 and sides 123A, 124A of the cross section of the second resonator 120 define a height direction of the second resonator 120. Lastly, a center line of the resonator is defined as a line extending in parallel to the guide direction and intersecting the cross section of the resonator in the center of the cross section.

The width of the first resonator 110 in its width direction is denoted by a1 (i.e. the length of sides 111A, 112A), and the height of the first resonator 110 in its height direction is denoted by b1 (i.e. the length of sides 113A, 114A). Likewise, the width of the second resonator 120 in its width direction is denoted by a2 (i.e. the length of sides 121A, 122A), and the height of the second resonator in its height direction is denoted by b2 (i.e. the length of sides 123A, 124A). By definition, we have a1>b1 and a2>b2. Typically, resonators of rectangular waveguide have a ratio of height to width (aspect ratio) of 1:2. However, the present invention is applicable to resonators having arbitrary aspect ratio 1:x with x>1. Further, the electrical length of the first resonator 110 in its guide direction is denoted by l1 and the electrical length of the second resonator 120 in its guide direction is denoted by l2. Typically, resonators of rectangular waveguide have an electrical length that corresponds to an integer multiple of half the wavelength of the desired base mode of the resonator.

In the first embodiment, the electrical length l1 of the first resonator 110 and the electrical length l2 of the second resonator 120 are design parameters of the rectangular waveguide filter 100.

The first resonator 110 is bounded by four lateral walls 111, 112, 113, 114 and two end walls 115, 116 which are all metallic walls. Lateral walls of the first resonator 110 are those walls of the first resonator 110 that extend in parallel to the guide direction of the first resonator 110, whereas end walls of the first resonator 110 are those walls that extend in a plane perpendicular to the guide direction of the first resonator 110. Of the four lateral walls 111, 112, 113, 114, those two corresponding to broad sides (i.e. longer sides) of the cross section of the first resonator 110, namely sides 111A, 112A, are the top wall 111 and bottom wall 112 of the first resonator 110 (first lateral walls, or broad walls of the first resonator). Accordingly, the top and bottom walls 111, 112 of the first resonator 110 extend in a plane spanned by the guide direction and the width direction of the first resonator 110 (i.e. spanned by the z-axis and the x-axis). On the other hand, of the four lateral walls 111, 112, 113, 114 those two corresponding to narrow sides (i.e. shorter sides) of the cross section of the first resonator 110, namely sides 113A, 114A, are the left and right walls 113, 114 of the first resonator 110 (lateral walls of the first resonator other than the first lateral walls, or narrow walls of the first resonator).

Likewise, the second resonator 120 is bounded by four lateral walls 121, 122, 123, 124 and two end walls 125, 126 which are all metallic walls. Lateral walls of the second resonator 120 are those walls of the second resonator 120 that extend in parallel to the guide direction of the second resonator 120, whereas end walls of the second resonator 120 are those walls that extend in a plane perpendicular to the guide direction of the second resonator 120. Of the four lateral walls 121, 122, 123, 124, those two corresponding to broad sides (i.e. longer sides) of the cross section of the second resonator 120, namely sides 121A, 122A, are the top wall 121 and bottom wall 122 of the second resonator 120 (second lateral walls, or broad walls of the second resonator). Accordingly, the top and bottom walls 121, 122 of the second resonator 120 extend in a plane spanned by the guide direction and the width direction of the second resonator 120 (i.e. spanned by the z-axis and the x-axis). On the other hand, of the four lateral walls 121, 122, 123, 124 those two corresponding to narrow sides (i.e. shorter sides) of the cross section of the second resonator 120, namely sides 123A, 124A, are the left and right walls 123, 124 of the second resonator 120 (lateral walls of the second resonator other than the second lateral walls, or narrow walls of the second resonator).

As can be seen in FIGS. 1A and 1C, the first and second resonators 110, 120 have substantially identical width and height, i.e. a1=a2 and b1=b2. Moreover, the first and second resonators 110, 120 are arranged so that their guide directions extend in parallel and also their width and height directions, respectively, extend in parallel. Further, the first and second resonators 110, 120 are arranged so that the narrow walls (i.e. the left and right walls 113, 114) of the first resonator 110 are aligned with the respective narrow walls (i.e. the left and right walls 123, 124) of the second resonator 120. In other words, the second resonator 120 is shifted with respect to the first resonator 110 in the guide direction and in the height direction, but not in the width direction. Since the guide directions, width direction and height directions of the first and second resonators 110, 120, respectively, extend in parallel to each other, in the following wherever applicable it will be referred simply to the guide direction, the width direction and the height direction without specifying one of the first and second resonators 110, 120.

As can be seen in FIGS. 1A and 1B, one of the broad walls of the first resonator 110 (one of the first lateral walls, i.e. one of the top and bottom walls 111, 112) partially faces one of the broad walls of the second resonator 120 (one of the second lateral walls, i.e. one of the top and bottom walls 121, 122). Specifically, the top wall 111 of the first resonator 110 partially faces the bottom wall 122 of the second resonator 120. In other words, when seen along the height direction, the first and second resonators 110, 120 are partially overlapping.

As can be seen in FIG. 1B, the top wall 111 of the first resonator 110 has an aperture 111B (first aperture) and the bottom wall 122 of the second resonator has an aperture 122B (second aperture). The first and second apertures 111B, 122B are of substantial identical shape and size. Specifically, the first and second apertures 111B, 122B have the shape of a rectangle that extends over the full width of the top wall 111 of the first resonator 110 and the bottom wall 122 of the second resonator 120, respectively. The first and second apertures 111B, 122B are aligned with each other, i.e. the first and second apertures 111B, 122B fall in line with each other when seen along the height direction. In other words, each of connecting walls between corresponding boundaries of the first and second openings 111B, 122B would extend in parallel to respective ones of the narrow walls and the end walls of the first and second resonators 110, 120.

The first resonator 110 is electromagnetically coupled to the second resonator 120 through the first aperture 111B and the second aperture 122B, for which reason the first and second apertures 111B, 122B may also be referred to as coupling apertures. In other words, the electromagnetic field present in the first resonator 110 may interact with the electromagnetic field present in the second resonator 120 through the first aperture 111B and the second aperture 122B.

The amount of shift of the second resonator 120 with respect to the first resonator 110 in the guide direction is a design parameter of the rectangular waveguide filter 100 and of the corresponding group of resonators, respectively. Likewise, the position along the guide direction of the first aperture 111B in the top wall 111 of the first resonator 110 and the position along the guide direction of the second aperture 122B in the bottom wall 122 of the second resonator 120 are design parameters of the rectangular waveguide filter 100 and of the corresponding group of resonators, respectively.

Between the top wall 111 of the first resonator 110 and the bottom wall 122 of the second resonator 120, a connecting section 150 is provided, having four connecting walls between corresponding boundaries of the first and second apertures 111B, 122B, each of which extends in parallel to respective ones of the narrow walls and the end walls of the first and second resonators 110, 120. That is, each of the four connecting walls extends in a respective plane perpendicular to the top wall 111 of the first resonator 110 and the bottom wall 122 of the second resonator 120. The connecting walls of the connecting section 150 may simply result from a finite thickness d1 of the top wall 111 of the first resonator 110 and a finite thickness d2 of the bottom wall 122 of the second resonator 120. In this case, a height of the connecting section 150 in the height direction is given by d1+d2. Alternatively, the connecting section 150 may have a height in the height direction that is larger than d1+d2.

Summarizing the configuration of the microwave filter according to the first embodiment, the first and second resonators 110, 120 are coupled to each other via the top and bottom walls rather than the end walls. Accordingly, a length of the resulting microwave filter, and consequently also a size of the projection of the resulting filter on a mounting surface extending in parallel to the top and bottom faces 111, 112, 211, 212 of the first and second resonators 110, 120 (i.e. the footprint of the filter) is reduced. On the other hand, the resulting microwave filter is symmetric with respect to a symmetry plane that extends along the guide direction and the height direction (i.e. along the z-axis and the y-axis), so that the microwave filter can be manufactured using the well-known clam-shell approach. According to the clam-shell approach, a filter is cut longitudinally in two symmetrical parts. Each of these parts is machined separately and the filter is realized by assembly of the two parts. Thus, the resulting microwave filter can be manufactured in a particularly simple and inexpensive manner. Also, using the inventive configuration, tuning screws can be included in the center of the resonators without difficulty.

Further, since the first and second resonators 110, 120 are provided at different levels along the height direction, i.e. shifted with respect to each other along the height direction, the first resonator 110 can be coupled to a third resonator that is arranged below the second resonator 120 and in-line with the first resonator 110. Thus, couplings between non-adjacent resonators (i.e. non-adjacent along the RF-path, assuming that the third resonator is also coupled to the second resonator 120) become possible, which allows implementing more complex transfer functions that go beyond the standard Chebyshev transfer functions, such as transfer functions displaying transmission zeros at finite frequency, without having to fold the filter in the horizontal plane. Examples of rectangular waveguide filters featuring couplings between non-adjacent resonators will be presented below.

In the above, the second resonator 120 has been described to be arranged on top of the first resonator 110. Alternatively, the first resonator 110 may be arranged on top of the second resonator 120. In this case, the bottom wall 112 of the first resonator 110 would partially face the top wall 121 of the second resonator 120, the first aperture would be provided in the bottom wall 112 of the first resonator 110, and the second aperture would be provided in the top wall 121 of the second resonator 120.

Further, in the above description the inventive group of resonators has been described to be interposed between the first and second coupling sections 170, 175, coupling the first and second resonators 110, 120 to the input port 160 and the output port 165, respectively. However, the inventive group of resonators can be used in any other filter configuration, i.e. interposed between further resonators or groups of resonators. Evidently, the advantage of a reduction of the footprint of the filter is likewise achieved if two adjacent resonators that are coupled via their end walls are replaced by the inventive group of resonators in which the resonators are coupled to each other via their top and bottom walls, respectively. In addition, also the advantage of being able to implement more complex transfer functions is achieved if two adjacent resonators that are coupled via their end walls are replaced by the inventive group of resonators.

Further filter configurations comprising the inventive group of resonators are discussed below. However, no limitation of the invention is intended by the particular choice of the presented filter configurations.

FIG. 1E illustrates the electrical performance of the rectangular waveguide filter 100 of FIGS. 1A to 1D. The abscissa indicates the frequency in units of GHz, and the ordinate indicates the S-parameter of the rectangular waveguide filter 100 in units of dB. Graph 191 indicates the S21-component of the S-parameter, and graph 192 indicates the S11-component of the S-parameter. For reasons of symmetry, S11=S22 and S21=S12 hold for the rectangular waveguide filter 100. As can be seen from FIG. 1E, S11 has two poles in the pass-band indicated by S21 (in the figure at about 12.3 and 12.5 GHz). In the case of the rectangular waveguide filter 100, S21 does not have a transmission zero at finite frequency.

The group of resonators 100 shown in FIGS. 1A to 1D may be referred to as the basic building block of the invention. This basic building block can be used to implement a number of microwave filters according to the embodiments of the invention described below. Of these, the second embodiment relates to a third order filter comprising the basic building block, and the third embodiment relates to a fourth order filter comprising the basic building block.

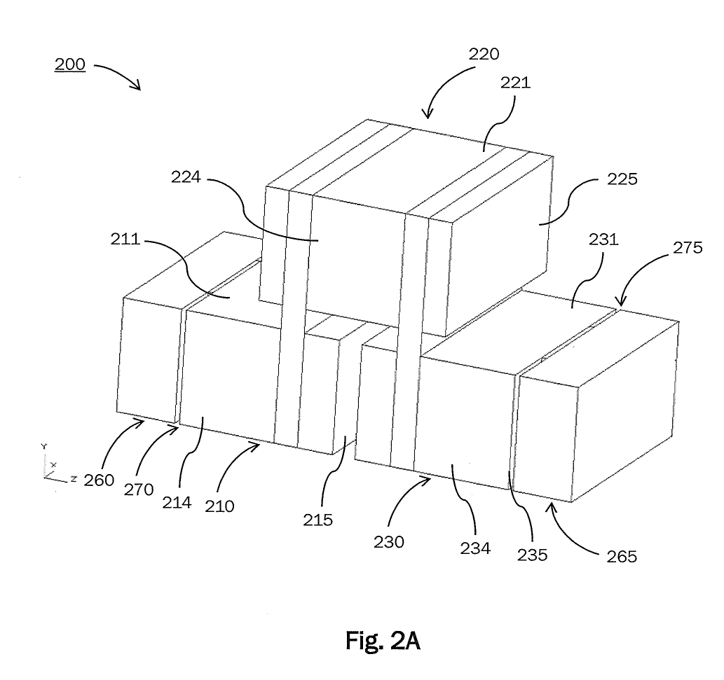

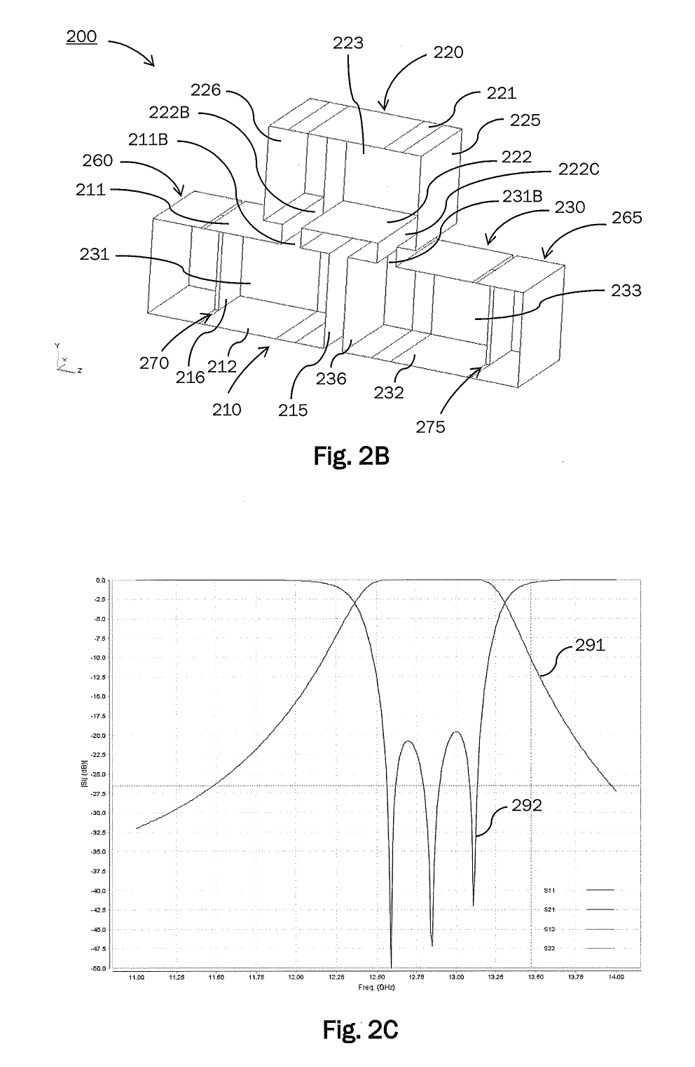

A rectangular waveguide filter 200 according to the second embodiment of the invention will be described with reference to FIGS. 2A to 2C. FIG. 2A is a perspective view of the rectangular waveguide filter 200, FIG. 2B is a sagittal cut through the rectangular waveguide filter 200, and FIG. 2C illustrates the electrical performance of the rectangular waveguide filter 200.

The rectangular waveguide filter 200 comprises a group of resonators of a first resonator 210, a second resonator 220 and a third resonator 230, each of which is a rectangular waveguide resonator, interposed between an input port 260 and an output port 265. The first resonator 210 is coupled to the input port 260 through a first coupling section 270, and the third resonator 230 is coupled to the output port 265 through a second coupling section 275. Exemplarily, inductive coupling sections are illustrated as the first and second coupling sections 270, 275. However, instead of inductive coupling sections, also alternative coupling sections that are readily apparent to the expert of skill in the art can be used for coupling the first and third resonators 210, 230 to the input and output ports 260, 265, respectively, e.g. capacitive coupling sections or hybrid coupling sections.

Accordingly, the group of resonators of the second embodiment of the invention differs from the group of resonators of the first embodiment by the presence of the third resonator 230.

For a definition of the walls and the relative arrangement of the first and second resonators 210, 220 it is referred to the above description of the first and second resonators 110, 120 of the first embodiment. Thus, the second resonator 220 is arranged on top of the first resonator 210 so that the one of the broad walls of the first resonator 210 (one of the first lateral walls of the firsf resonator, i.e. one of the top and bottom walls 211, 212) partially faces one of the broad walls of the second resonator 220 (one of the second lateral walls of the second resonator, i.e. one of the top and bottom walls 221, 222). Specifically, the top wall 211 of the first resonator 210 partially faces the bottom wall 222 of the second resonator 220. Further, the first aperture 211B is provided in the top wall 211 of the first resonator 210, the second aperture 222B is provided in the bottom wall 222 of the second resonator 220, and the first resonator 210 is electromagnetically coupled to the second resonator 220 through the first aperture 211B and the second aperture 222B.

As in the first embodiment, the first and second resonators 210, 220 have substantially identical width and height, i.e. a1=a2 and b1=b2. Moreover, the first and second resonators 210, 220 are arranged so that their guide directions extend in parallel and also their width and height directions, respectively, extend in parallel. Further, the first and second resonators 210, 220 are arranged so that the narrow walls of the first resonator 210 (the lateral walls of the first resonator other than the first lateral walls, i.e. the left and right walls 213, 214) are aligned with the respective narrow walls of the second resonator 220 (the lateral walls of the second resonator other than the second lateral walls, i.e. the left and right walls 223, 224). In other words, the second resonator 220 is shifted with respect to the first resonator 210 in the guide direction and in the height direction, but not in the width direction.

Summarizing, also in the second embodiment, the first and second resonators 210, 220 are provided at different levels along the height direction and coupled to each other via their top and bottom walls rather than their end walls.

The third resonator 230 is bounded by four lateral walls 231, 232, 233, 234 and two end walls 235, 236 which are all metallic walls. Lateral walls of the third resonator 230 are those walls of the third resonator 230 that extend in parallel to the guide direction of the third resonator 230, whereas end walls of the third resonator 230 are those walls that extend in a plane perpendicular to the guide direction of the third resonator 230. Of the four lateral walls 231, 232, 233, 234, those two corresponding to broad sides (i.e. longer sides) of the cross section of the third resonator 230 are the top wall 231 and bottom wall 232 of the third resonator 230 (third lateral wills, or broad walls of the third resonator). Accordingly, the top and bottom walls 231, 232 of the third resonator 230 extend in a plane spanned by the guide direction and the width direction of the third resonator 230 (i.e. spanned by the z-axis and the x-axis). On the other hand, of the four lateral walls 231, 232, 233, 234 those two corresponding to narrow sides (i.e. shorter sides) of the cross section of the third resonator 230 are the left and right walls 233, 234 of the third resonator 230 (lateral walls of the third resonator other than the third lateral walls, or narrow walls of the third resonator).

As can be seen in FIG. 2A, the first, second and third resonators 210, 220, 230 have substantially identical width and height, i.e. a1=a2=a3 and b1=b2=b3, wherein the width of the third resonator 230 in its width direction is denoted by a3, and the height of the third resonator 230 in its height direction is denoted by b3.

In the second embodiment, an electrical length l1 of the first resonator 210, an electrical length l2 of the second resonator 220, and an electrical length l3 of the third resonator 230 are design parameters of the rectangular waveguide filter 200.

The third resonator 230 is arranged with respect to the first and second resonators 210, 220 so that its guide direction extends in parallel to the guide directions of the first and second resonators 210, 220, and also its width direction and height direction, extends in parallel to the width directions and height directions, respectively, of the first and second resonators 210, 220. Since the guide directions, width direction and height directions of the first, second and third resonators 210, 220, 230, respectively, extend in parallel to each other, it the following wherever applicable it will be referred simply to the guide direction, the width direction and the height direction without specifying one of the first, second and third resonators 210, 220, 230.

The third resonator 230 is further arranged so that the narrow walls of the third resonator 230 (the lateral walls of the third resonator other than the third lateral walls, i.e. the left and right walls 233, 234) are aligned with the respective narrow walls of the first and second resonators 210, 220 (the lateral walls of the first and second resonators other than the first and second lateral walls, i.e. the left and right walls 213, 214, 223, 224). In other words, the third resonator 230 is shifted with respect to the first resonator 210 and the second resonator 220 in the guide direction and in the height direction, but not in the width direction. Specifically, the third resonator 230 is arranged relative to the first and second resonators 210, 220 so that one of the end walls 235, 236 of the third resonator 230 faces one of the end walls 215, 216 of the first resonator 210, and so that one of the broad walls of the third resonator 230 (one of the third lateral walls, i.e. one of the top and bottom walls 231, 232) partially faces the one of the broad walls of the second resonator 220 (the one of the second lateral walls of the second resonator, i.e. the one of the top and bottom walls 221, 222). Specifically, the top wall 231 of the third resonator 230 partially faces the bottom wall 222 of the second resonator 220. In other words, the third resonator 230 is arranged so that its cross section is aligned with the cross section of the first resonator 210 and so that it is arranged below the second resonator 220, i.e. so that when seen along the height direction, the second and third resonators 220, 230 are partially overlapping. Thus, the first and third resonators 210, 230 are arranged at a first level along the height direction and the second resonator 220 is arranged at a second level along the height direction different from the first level.

As can be seen from FIGS. 2A and 2B, the bottom wall 222 of the second resonator 220 has a third aperture 222C which is distinct from the second aperture 222B, and the top wall 231 of the third resonator 230 has a fourth aperture 231B. The third and fourth apertures 222C, 231B are of substantial identical shape and size. Specifically, the third and fourth apertures 222C, 231B have the shape of a rectangle that extends over the full width of the bottom wall 222 of the first resonator 220 and the top wall 231 of the third resonator 230, respectively. The third and fourth apertures 222C, 231B are aligned with each other, i.e. the third and fourth apertures 222C, 231B fall in line with each other when seen along the height direction. In other words, connecting walls between corresponding boundaries of the third and fourth apertures 222C, 231B would extend in parallel to respective ones of the narrow walls and the end walls of the first, second, and third resonators 210, 220, 230.

The second resonator is electromagnetically coupled to the third resonator through the third aperture 222C and the fourth aperture 231B, for which reason the third and fourth apertures 222C, 231B may also be referred to as coupling apertures. In other words, the electromagnetic field present in the second resonator may interact with 11D the electromagnetic field present in the third resonator through the third aperture 222C and the fourth aperture 231B. Thus, also the second and third resonators 220, 230 are coupled to each other via their top and bottom walls rather than their end walls.

In the above, the shift of the second resonator 220 with respect to the first resonator 210 in the guide direction and the shift of the third resonator 230 with respect to the second resonator 220 in the guide direction are design parameters of the rectangular waveguide filter 200 and of the corresponding group of resonators, respectively. Likewise, the position along the guide direction of the first aperture 211B in the top wall 211 of the first resonator 210, the position along the guide direction of the second aperture 222B in the bottom wall 222 of the second resonator 220, the position along the guide direction of the third aperture 222C in the bottom wall 222 of the second resonator 220, and the position along the guide direction of the fourth aperture 231B in the top wall 231 of the third resonator 230 are design parameters of the rectangular waveguide filter 200 and of the corresponding group of resonators, respectively.

Between the top wall 211 of the first resonator 210 and the bottom wall 222 of the second resonator 220, and between the top wall 231 of the third resonator 230 and the bottom wall 222 of the second resonator 220, connecting sections 250, 255, respectively, are provided, each connection section 250, 255 having four connecting walls between corresponding boundaries of the first and second openings 221B, 222B, and the third and fourth openings 222C, 231B, respectively, each of which extends in parallel to respective ones of the narrow walls and the end walls of the first, second, and third resonators 210, 220, 230. That is, each of the four connecting walls extends in a respective plane perpendicular to e.g. the top wall 221 of the first resonator 210, the bottom wall 222 of the second resonator 220, and the top wall 231 of the third resonator 230. The connecting walls of the connecting sections 250, 255 may simply result from a finite thickness d1 of the top wall 211 of the first resonator 210 and a finite thickness d2 of the bottom wall 222 of the second resonator 220, or the finite thickness d2 of the bottom wall 222 of the second resonator 220 and a finite thickness d3=d1 of the top wall 231 of the third resonator 230. In this case, a height of the connecting sections 250, 255 in the height direction is given by d1+d2. Alternatively, the connecting sections 250, 255 may have a height in the height direction that is larger than d1+d2.

In the above, the inventive group of resonators has been described to be interposed between the input port 260 and the output port 265. However, the inventive group of resonators can be used in any other filter configuration, i.e. interposed between further resonators or groups of resonators. Analogous statements are understood to apply also to the further embodiments of the invention that will be described below, and will not be repeated.

FIG. 2C illustrates the electrical performance of the rectangular waveguide filter 200 of FIGS. 2A and 2B. The abscissa indicates the frequency in units of GHz, and the ordinate indicates the S-parameter of the rectangular waveguide filter 200 in units of dB. Graph 291 indicates the S21-component of the S-parameter, and graph 292 indicates the S11-component of the S-parameter. For reasons of symmetry, S11=S22 and S21=S12 hold for the rectangular waveguide filter 200. As can be seen from FIG. 2C, S11 has three poles in the pass-band indicated by S21 (in the figure at about 12.6, 12.85 and 13.1 GHz). In the case of the rectangular waveguide filter 200, S21 does not have a transmission zero at finite frequency.

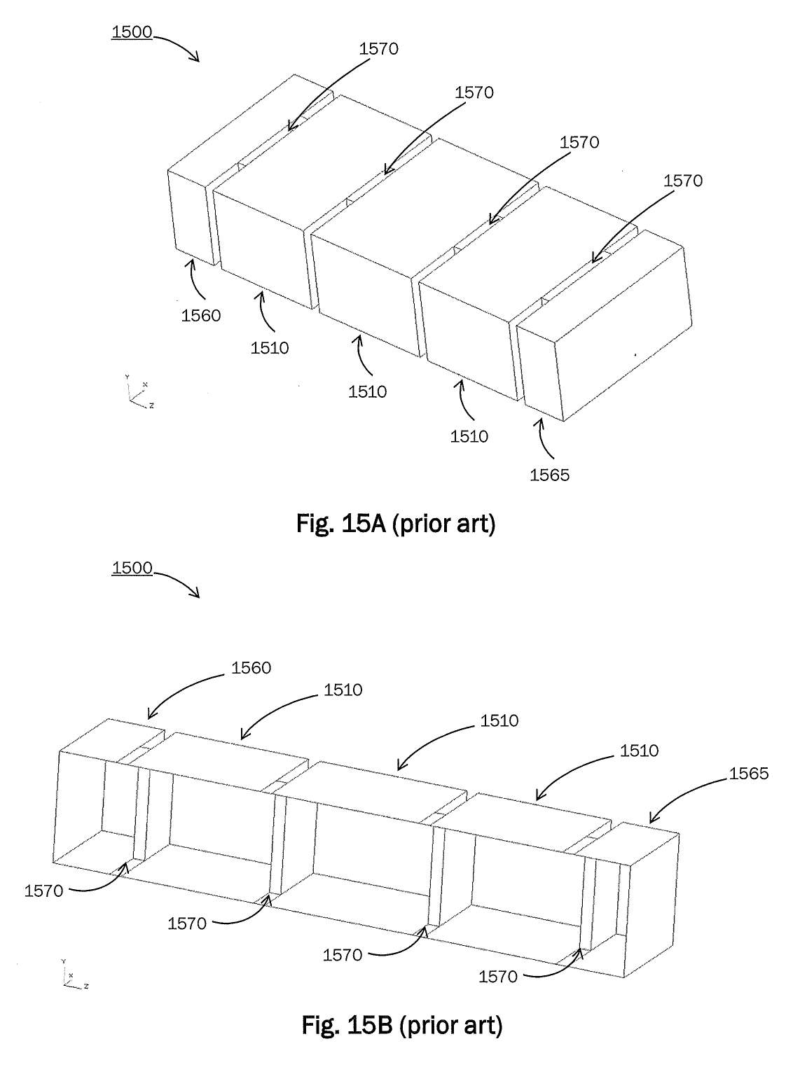

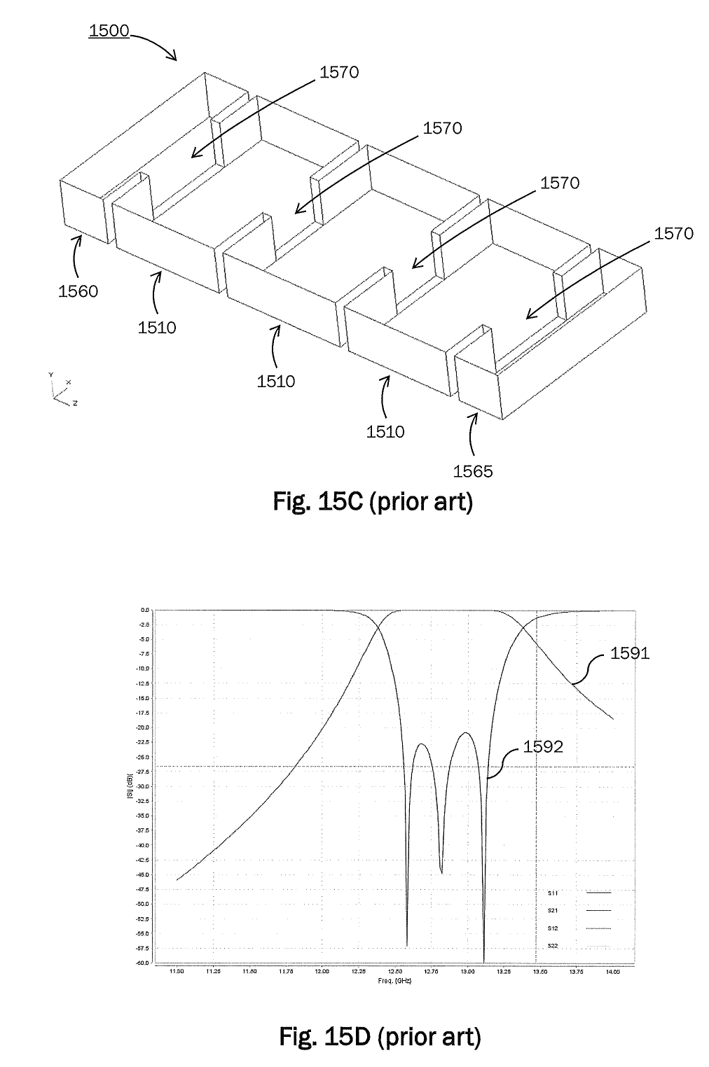

Thus, the rectangular waveguide filter 200 of the second embodiment is a three pole filter (third order filter). A conventional three pole filter 1500 known in the art is illustrated in FIGS. 15A to 15D, of which FIG. 15A is a perspective view of the conventional three pole filter 1500, FIG. 15B is a sagittal cut through the conventional three pole filter 1500, FIG. 15C is a horizontal cut through the conventional three pole filter 1500, and FIG. 15D illustrates the electrical performance of the conventional three pole filter 1500.

The conventional three pole filter 1500 comprises a group of three rectangular waveguide resonators 1510 interposed between an input port 1560 and an output port 1565, and coupled to each other and to the input/output ports 1560, 1565 by inductive coupling sections 1570.

In FIG. 15D, the abscissa indicates the frequency in units of GHz, and the ordinate indicates the S-parameter of the conventional three pole filter 1500 in units of dB. Graph 1591 indicates the S21-component of the S-parameter, and graph 1592 indicates the S11-component of the S-parameter. For reasons of symmetry, S11=S22 and S21=S12 hold for the conventional three pole filter 1500. As can be seen from a comparison of FIG. 2C and FIG. 15D, the rectangular waveguide filter 200 and the conventional three pole filter′1500 have comparable electrical performances.

On the other hand, the rectangular waveguide filter 200 is significantly shorter than the conventional three pole filter 1500. For a center frequency of the pass-band of about 12.8 GHz, the rectangular waveguide filter 200 has a length of about 28.92 mm, whereas the conventional three pole filter 1500 has a length of about 40.64 mm. Thus, by employing the inventive group of resonators, a length reduction as well as a corresponding reduction of footprint for a three pole filter of about 29% can be achieved.

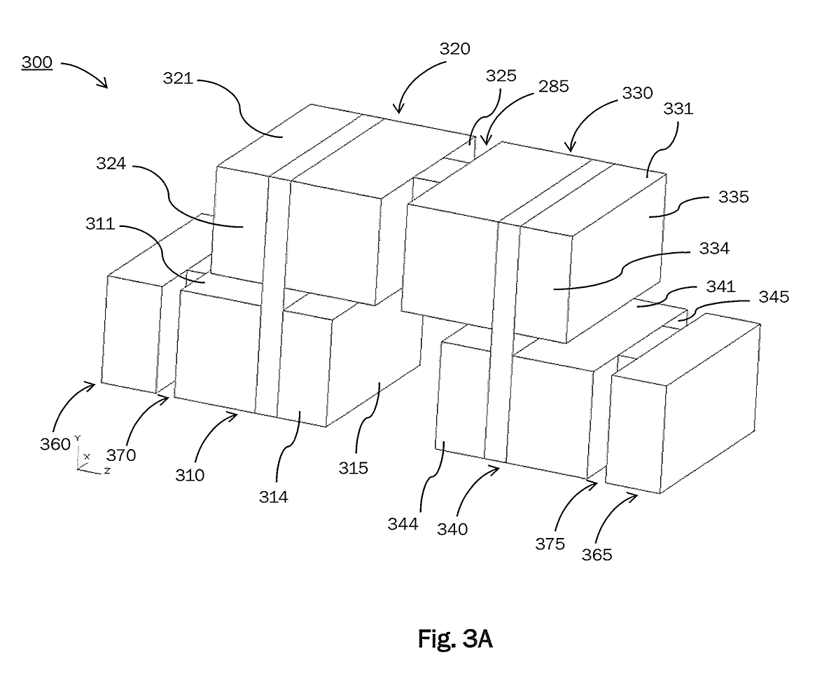

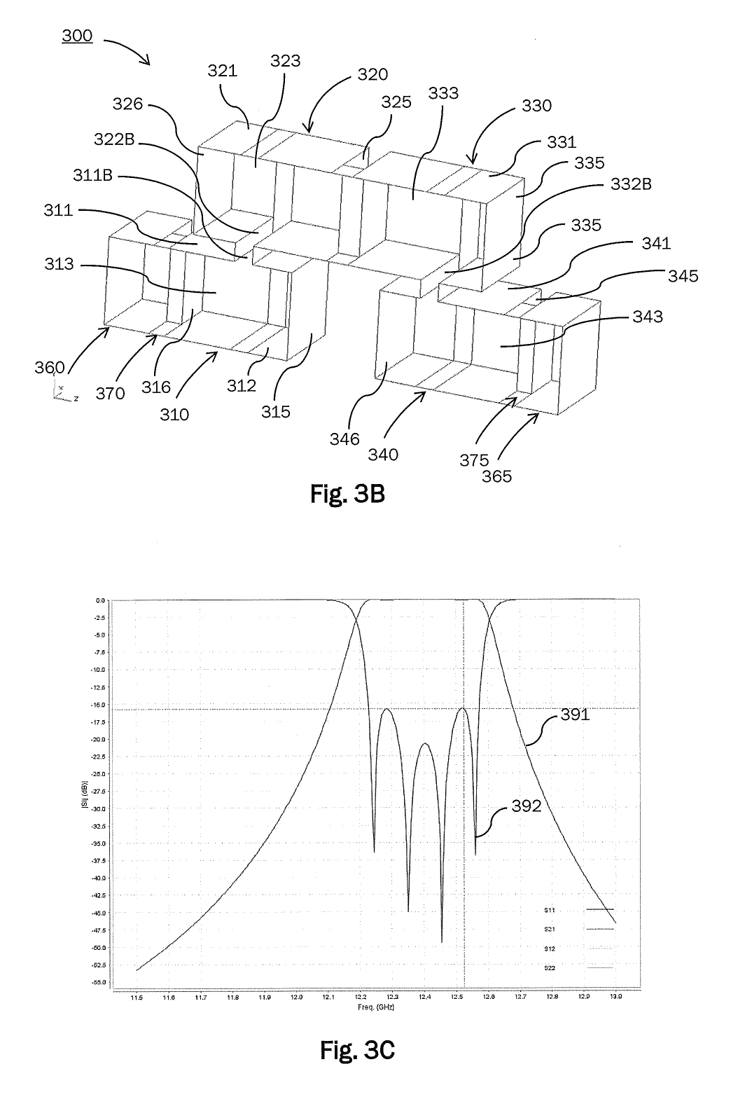

Next, a rectangular waveguide filter 300 according to a third embodiment of the invention will be described with reference to FIGS. 3A to 3C. FIG. 3A is a perspective view of the rectangular waveguide filter 300, FIG. 3B is a sagittal cut through the rectangular waveguide filter 300, and FIG. 3C illustrates the electrical performance of the rectangular waveguide filter 300.

The rectangular waveguide filter 300 comprises a group of resonators of a first resonator 310, a second resonator 320, a third resonator 330, and a fourth resonator 340, each of which is a rectangular waveguide resonator, interposed between an input port 360 and an output port 365. The first resonator 310 is coupled to the input port 360 through a first coupling section 370, and the fourth resonator 340 is coupled to the output port 365 through a second coupling section 375. Exemplarily, inductive coupling sections are illustrated as the first and second coupling sections 370, 375. However, instead of inductive coupling sections, also alternative coupling sections that are readily apparent to the expert of skill in the art can be used for coupling the first and fourth resonators 310, 340 to the input and output ports 360, 365, respectively, e.g. capacitive coupling sections or hybrid coupling sections.

Accordingly, the group of resonators in the third embodiment of the invention differs from the group of resonators in the first embodiment by the presence of the third resonator 330 and the fourth resonator 340.

For a definition of the faces and the relative arrangement of the first and second resonators 310, 320 it is referred to the above description of the first embodiment. As in the first and second embodiments, without intended limitation, the second resonator 320 is arranged on top of the first resonator 310. Thus, one of the broad walls of the first resonator 310 (one of the first lateral walls of the first resonator, i.e. one of the top and bottom walls 311, 312) partially faces one of the broad walls of the second resonator 320 (one of the second lateral walls of the second resonator, i.e. one of top and bottom walls 321, 322). Specifically, the top wall 311 of the first resonator 310 partially faces the bottom wall 322 of the second resonator 320. Further, a first aperture 311B is provided in the top wall 311 of the first resonator 310, a second aperture 322B is provided in the bottom wall 322 of the second resonator 320, and the first resonator 310 is electromagnetically coupled to the second resonator 320 through the first aperture 311B and the second aperture 322B. As regards alignment of directions and walls of the first and second resonators 310, 320, it is referred to the description of the first embodiment.

Summarizing, also in the third embodiment, the first and second resonators 310, 320 are provided at different levels along the height direction and coupled to each other via their top and bottom walls rather than their end walls.

For a definition of the walls of the third resonator 330 it can be referred to the above description of the second embodiment, wherein however in the third embodiment the arrangement of the third resonator 330 with respect to the first and second resonators 310, 320 differs from the arrangement in the second embodiment. The arrangement of the third resonator 330 with respect to the first and second resonators 310, 320 will be described below.

The fourth resonator 340 is bounded by four lateral walls 341, 342, 343, 344 and two end walls 345, 346 which are all metallic walls. Lateral walls of the fourth resonator 340 are those walls of the fourth resonator 340 that extend in parallel to the guide direction of the fourth resonator 340, whereas end walls of the fourth resonator 340 are those walls that extend in a plane perpendicular to the guide direction of the fourth resonator 340. Of the four lateral walls 341, 342, 343, 344, those two corresponding to broad sides (i.e. longer sides) of the cross section of the fourth resonator 340 are the top wall 341 and bottom wall 342 of the fourth resonator 340 (fourth lateral walls, or broad walls of the fourth resonator). Accordingly, the top and bottom walls 341, 342 of the fourth resonator 340 extend in a plane spanned by the guide direction and the width direction of the fourth resonator 340 (i.e. spanned by the z-axis and the x-axis). On the other hand, of the four lateral walls 341, 342, 343, 344 those two corresponding to narrow sides (i.e. shorter sides) of the cross section of the fourth resonator 340 are the left and right walls 343, 344 of the fourth resonator 340 (lateral walls of the fourth resonator other than the fourth lateral walls, or narrow walls of the fourth resonator).

As can be seen in FIG. 3A, the first, second, third and fourth resonators 310, 320, 330, 340 have substantially identical width and height, i.e. a1=a2=a3=a4 and b1=b2=b3=b4, wherein the width of the fourth resonator 340 in its width direction is denoted by a4, and the height of the fourth resonator 340 in its height direction is denoted by b4.

In the third embodiment, an electrical length l1 of the first resonator 310, an electrical length l2 of the second resonator 320, an electrical length l3 of the third resonator 330, and an electrical length of the fourth resonator 340 are design parameters of the rectangular waveguide filter 300.

The third and fourth resonators 330, 340 are arranged with respect to the first and second resonators 310, 320 so that their guide directions extend in parallel to the guide directions of the first and second resonators 310, 320, and also their width directions and height directions, respectively, extend in parallel to the width directions and height directions of the first and second resonators 310, 320. Since the guide directions, width directions and height directions of the first, second, third and fourth resonators 310, 320, 330, 340, respectively, extend in parallel to each other, in the following wherever applicable it will be referred simply to the guide direction, the width direction and the height direction without specifying one of the first, second, third and fourth resonators 310, 320, 330, 340.

The third and fourth resonators 330, 340 are further arranged so that the narrow walls of the third resonator 330 and the narrow walls of the fourth resonator 340 are aligned with the respective narrow walls of the first and second resonators 310, 320.

The third resonator 330 is further arranged relative to the first and second resonators 310, 320 so that one of the end walls 335, 336 of the third resonator 330 faces one of the end walls 325, 326 of the second resonator 320. The fourth resonator 340 is arranged relative to the first, second and third resonators 310, 320, 330 so that one of the end walls 345, 346 of the fourth resonator 340 faces one of the end walls 315, 316 of the first resonator 310, and so that one of the broad walls of the fourth resonator 340 (one of the fourth lateral walls, i.e. one of the top and bottom walls 341, 342) partially faces one of the broad walls of the third resonator 330 (one of the third lateral walls, i.e. one of the top and bottom walls 331, 332). Specifically, the top wall 341 of the fourth resonator 340 partially faces the bottom wall 332 of the third resonator 330.

In other words, the third resonator 330 is arranged so that its cross section is aligned with the cross section of the second resonator 320. The fourth resonator 340 is arranged so that its cross section is aligned with the cross section of the first resonator 310, and so that it is arranged below the third resonator 330, i.e. so that when seen along the height direction, the third and fourth resonators 330, 340 are partially overlapping.

Thus, the third resonator 330 is shifted with respect to the first resonator 310 in the guide direction and in the height direction, but not in the width direction, and with respect to the second resonator 320 in the guide direction, but not in the width direction or the height direction. The fourth resonator 340 is shifted with respect to the first resonator 310 in the guide direction, but not in the width direction or the height direction, and with respect to the second resonator 320 in the guide direction and in the height direction, but not in the width direction. Put differently, the first and fourth resonators 310, 330 are arranged at a first level along the height direction and the second and third resonators 320, 330 are arranged at a second level along the height direction different from the first level.

The third resonator 330 is electromagnetically coupled to the second resonator 320 through an inductive coupling section 385 interposed between an aperture (coupling aperture) in the one of the end walls 325, 326 of the second resonator 320 and an aperture (coupling aperture) in the one of the end walls 335, 336 of the third resonator 330. Although an inductive coupling section 385 is exemplarily shown in FIGS. 3A and 3B, also an alternative coupling section that is readily apparent to the expert of skill in the art can be used for coupling the second and third resonators 320, 330, such as a capacitive coupling section or a hybrid coupling section.

As can be seen from FIGS. 3A and 3B, the bottom wall 332 of the third resonator 330 has a third aperture 332B, and the top wall 341 of the fourth resonator 340 has a fourth aperture 341B. The third and fourth apertures 332B, 341B are of substantial identical shape and size. Specifically, the third and fourth apertures 332B, 341B have the shape of a rectangle that extends over the full width of the bottom wall 332 of the third resonator 330 and the top wall 341 of the fourth resonator 340, respectively. The third and fourth apertures 332B, 341B are aligned with each other, i.e. the third and fourth apertures 332B, 341B fall in line with each other when seen along the height direction. In other words, each of connecting walls between corresponding boundaries of the third and fourth apertures 332B, 341B would extend in parallel to respective ones of the narrow walls and the end walls of the first, second, third, and fourth resonators 310, 320, 330, 340.

The third resonator is electromagnetically coupled to the fourth resonator through the third aperture 332B and the fourth aperture 341B, which for this reason may also be referred to as coupling apertures. In other words, the electromagnetic field present in the third resonator may interact with the electromagnetic field present in the fourth resonator through the third aperture 332B and the fourth aperture 341B.

Thus, also the third and fourth resonators 330, 340 are coupled to each other via their top and bottom walls rather than their end walls.

In the above, the shift of the second resonator 320 with respect to the first resonator 310 in the guide direction and the shift of the fourth resonator 340 with respect to the third resonator 330 in the guide direction are design parameters of the rectangular waveguide filter 300 and of the corresponding group of resonators, respectively. Likewise, the position along the guide direction of the first aperture 311B in the top wall 311 of the first resonator 310, the position along the guide direction of the second aperture 322B in the bottom wall 322 of the second resonator 320, the position along the guide direction of the third aperture 332B in the bottom wall 332 of the third resonator 330, and the position along the guide direction of the fourth aperture 341B in the top wall 341 of the fourth resonator 340 are design parameters of the rectangular waveguide filter 300 and of the corresponding group of resonators, respectively.

Between the top wall 311 of the first resonator 310 and the bottom wall 322 of the second resonator 320, and between the top wall 341 of the fourth resonator 340 and the bottom wall 332 of the third resonator 330, connecting sections 350, 355 are provided, each connecting section 350, 355 having four connecting walls between corresponding boundaries of the first and second apertures 321B, 322B, and the third and fourth apertures 332B, 341B, respectively, each of which extends in parallel to respective ones of the narrow walls and the end walls of the first, second, third, and fourth resonators 310, 320, 330, 340. That is, each of the four connecting walls extends in a respective plane perpendicular to e.g. the top wall 311 of the first resonator 310, the bottom wall 322 of the second resonator 320, the bottom wall 322 of the third resonator 330, and the top wall 341 of the fourth resonator 340. The connecting walls of the connecting sections 350, 355 may simply result from a finite thickness d1 of the top wall 311 of the first resonator 310 and a finite thickness d2 of the bottom wall 322 of the second resonator 320, or a finite thickness d3=d2 of the bottom wall 332 of the third resonator 330, and a finite thickness d4=d1 of the top wall 341 of the fourth resonator 340. In this case, a height of the connecting sections 350, 355 in the height direction is given by d1+d2. Alternatively, the connecting sections 350, 355 may have a height in the height direction that is larger than d1+d2.

FIG. 3C illustrates the electrical performance of the rectangular waveguide filter 300 of FIGS. 3A and 3B. The abscissa indicates the frequency in units of GHz, and the ordinate indicates the S-parameter of the rectangular waveguide filter 300 in units of dB. Graph 391 indicates the S21-component of the S-parameter, and graph 392 indicates the S11-component of the S-parameter. For reasons of symmetry, S11=S22 and S21=S12 hold for the rectangular waveguide filter 300. As can be seen from FIG. 3C, S11 has four poles in the pass-band indicated by S21 (in the figure at about 12.25, 12.35, 12.45, and 12.55 GHz). In the case of the rectangular waveguide filter 300, S21 does not have a transmission zero at finite frequency.

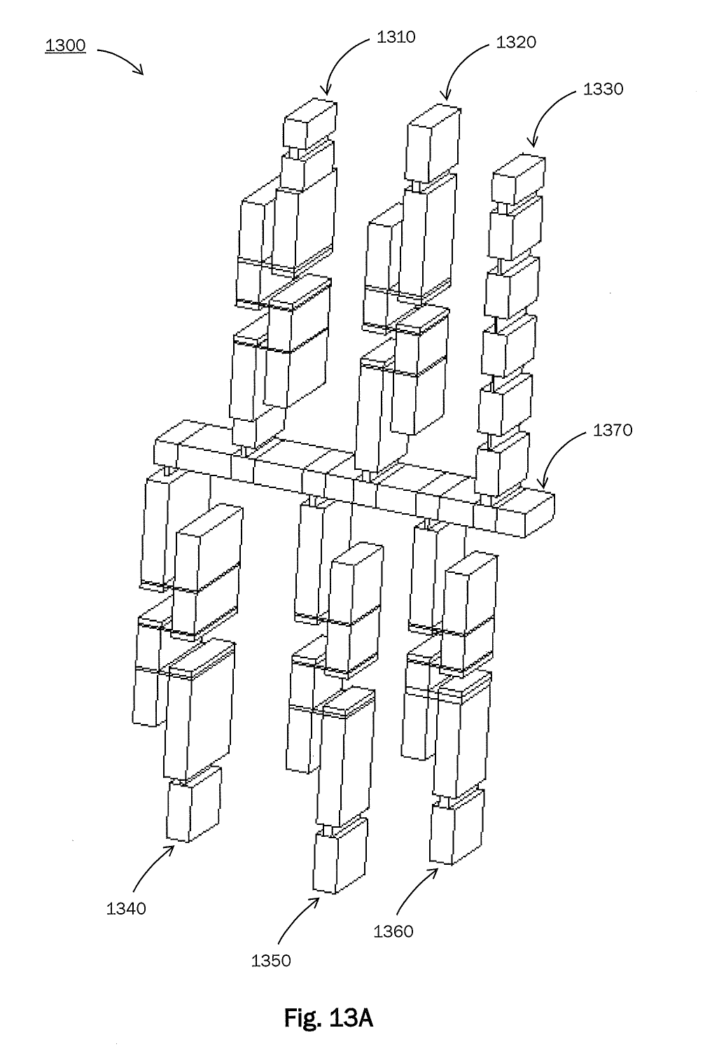

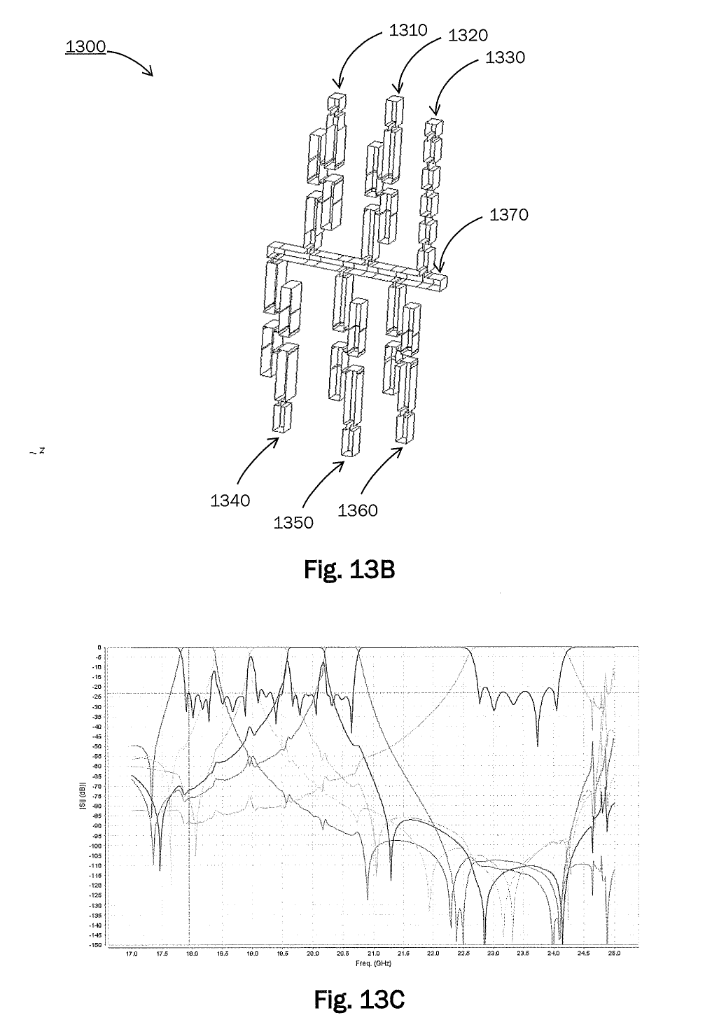

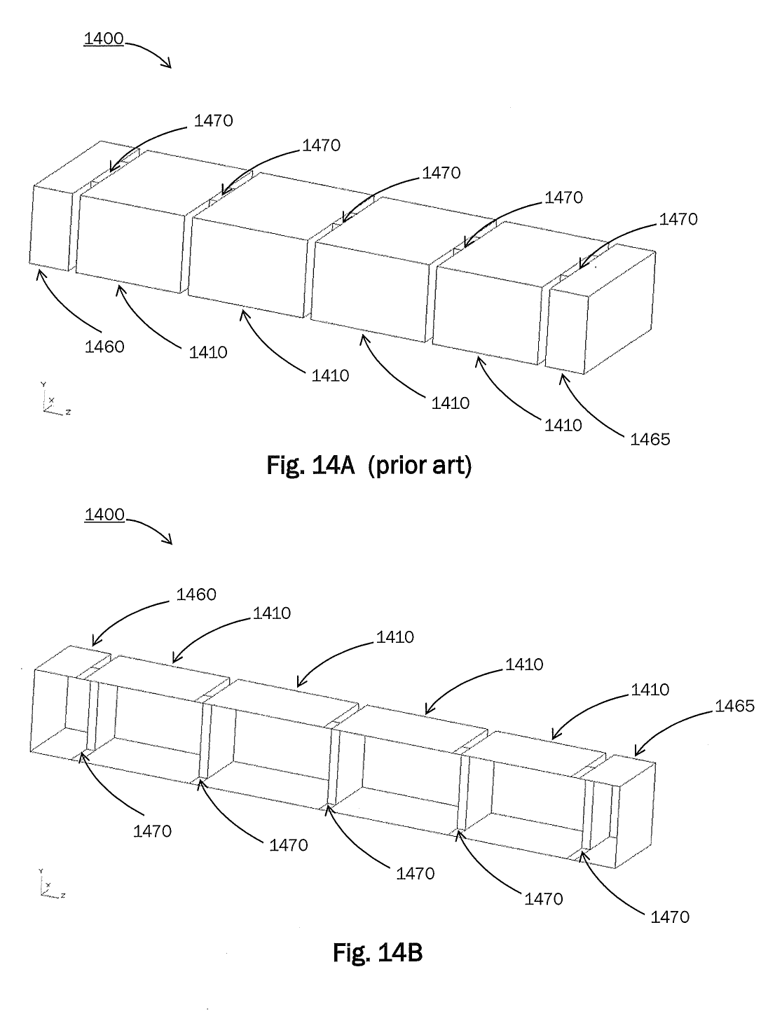

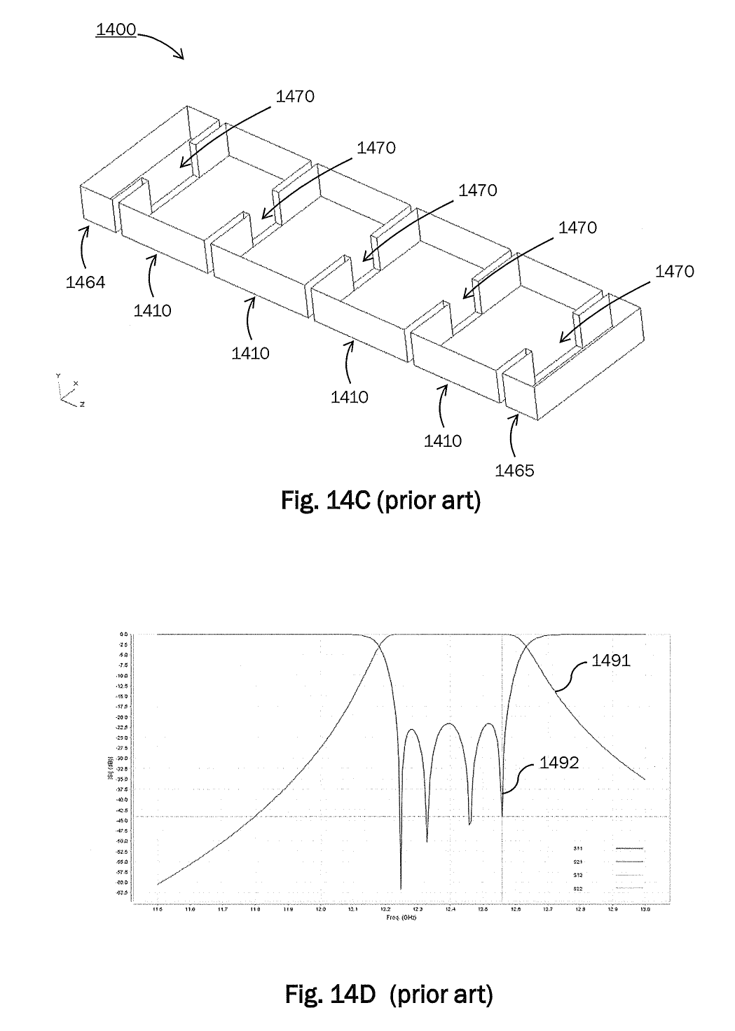

Thus, the rectangular waveguide filter 300 of the third embodiment is a four pole filter (fourth order filter). A conventional four pole filter 1400 known in the art is illustrated in FIGS. 14A to 14D, of which FIG. 14A is a perspective view of the conventional four pole filter 1400, FIG. 14B is a sagittal cut through the conventional four pole filter 1400, FIG. 13C is a horizontal cut through the conventional four pole filter 1400, and FIG. 14D illustrates the electrical performance of the conventional four pole filter 1400.

The conventional four pole filter 1400 comprises a group of four rectangular waveguide resonators 1410 interposed between an input port 1460 and an output port 1465, and coupled to each other and to the input/output ports 1460, 1465 by inductive coupling sections 1470.

The electrical performance of the conventional four pole filter 1400 is illustrated in FIG. 14D, in which the abscissa indicates the frequency in units of GHz, and the ordinate indicates the S-parameter of the conventional four pole filter 1400 in units of dB. Graph 1491 indicates the S21-component of the S-parameter, and graph 1492 indicates the S11-component of the S-parameter. For reasons of symmetry, S11=S22 and S21=S12 hold for the conventional four pole filter 1400. As can be seen from a comparison of FIG. 3C and FIG. 14D, the rectangular waveguide filter 300 and the conventional four pole filter 1400 have comparable electrical performances.

On the other hand, the rectangular waveguide filter 300 is significantly shorter than the conventional four pole filter 1400. For a center frequency of the pass-band of about 12.35 GHz, the rectangular waveguide filter 300 has a length of about 41.20 mm, whereas the conventional four pole filter 1400 has a length of about 61.04 mm. Thus, by employing the inventive group of resonators, a length reduction as well as a corresponding reduction of footprint for a four pole filter of about 32% can be achieved.

Next, the distribution of electric field intensity in the conventional four pole inductive filter 1400 and the four pole filter 300 of the third embodiment will be described. It turns out that the maximum electric field strength inside the inventive four pole filter 300 is only 15% higher than the maximum electric field strength inside the conventional four pole filter 1400. This indicates that a similar difference can be expected both in terms of maximum power and insertion loss capabilities.

As has been described above, the present invention allows for a reduction of the length and footprint of rectangular waveguide filters with only minimal adverse effects on the electrical performance. Another important advantage of the present invention is that it enables implementation of more complex transfer functions e.g. featuring transmission zeros at finite frequencies that enhance selectivity, or phase equalization. Specific embodiments of the present invention relating to filters with more complex transfer functions will be described next.

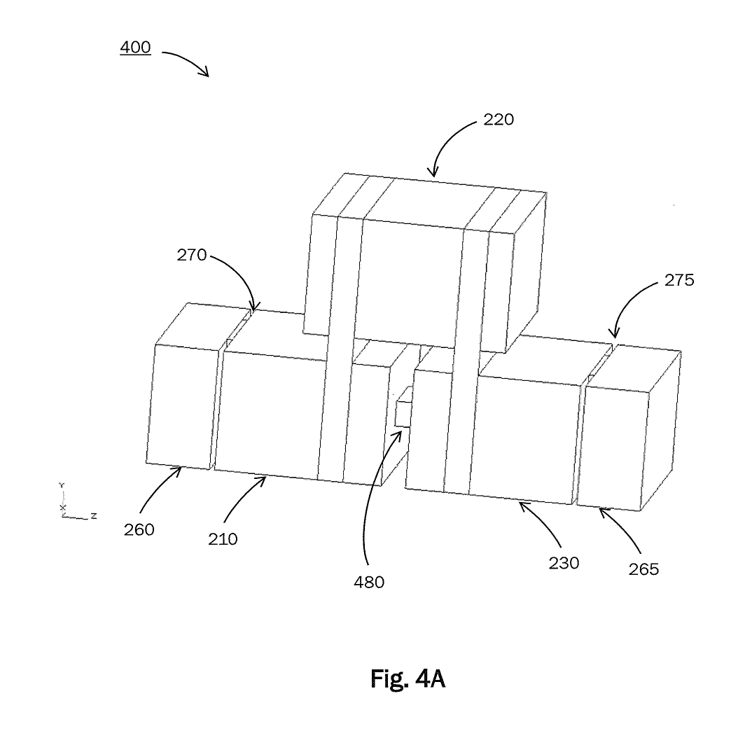

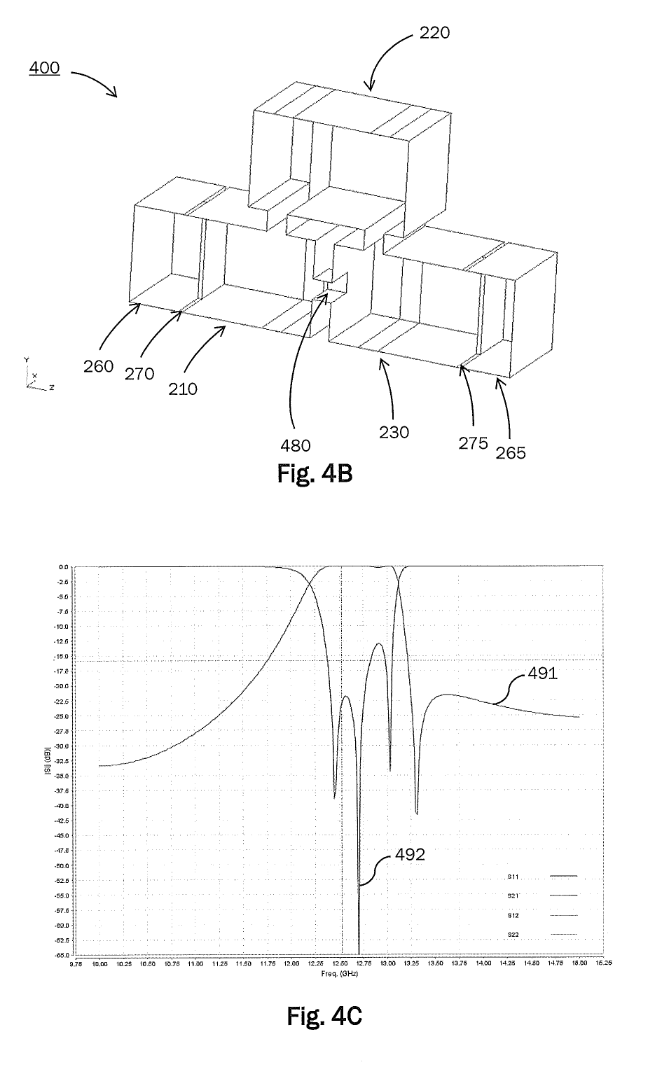

As a first example, a rectangular waveguide filter 400 according to a fourth embodiment of the invention, which is a three pole filter with a transmission zero above the pass-band, will be described with reference to FIGS. 4A to 4C. FIG. 4A is a perspective view of the rectangular waveguide filter 400, FIG. 4B is a sagittal cut through the rectangular waveguide filter 400, and FIG. 4C illustrates the electrical performance of the rectangular waveguide filter 400.

The rectangular waveguide filter 400 according to the fourth embodiment corresponds to the rectangular waveguide filter 200 according to the second embodiment with an additional hybrid coupling section 480 interposed between an aperture (coupling aperture) in the one of the end walls 215, 216 of the first resonator 210 and an aperture (coupling aperture) in the one of the end walls 235, 236 of the third resonator 230. However, instead of the hybrid coupling section 480, also alternative coupling sections, such as an inductive coupling section or a capacitive coupling section may be employed to couple the third resonator 230 to the first resonator 210. FIGS. 4A and 4B correspond to FIGS. 2A and 2B, so that reference signs indicating the walls of the respective resonators are omitted in FIGS. 4A and 4B.

FIG. 4C illustrates the electrical performance of the rectangular waveguide filter 400 of FIGS. 4A and 4B. The abscissa indicates the frequency in units of GHz, and the ordinate indicates the S-parameter of the rectangular waveguide filter 400 in units of dB. Graph 491 indicates the S21-component of the S-parameter, and graph 492 indicates the S11-component of the S-parameter. For reasons of symmetry, S11=S22 and S21=S12 hold for the rectangular waveguide filter 400. As can be seen from FIG. 4C, S11 has three poles in the pass-band indicated by S21 (in the figure at about 12.45, 12.7, and 13.0 GHz). Further, S21 has a transmission zero above the pass-band at about 13.3 GHz.

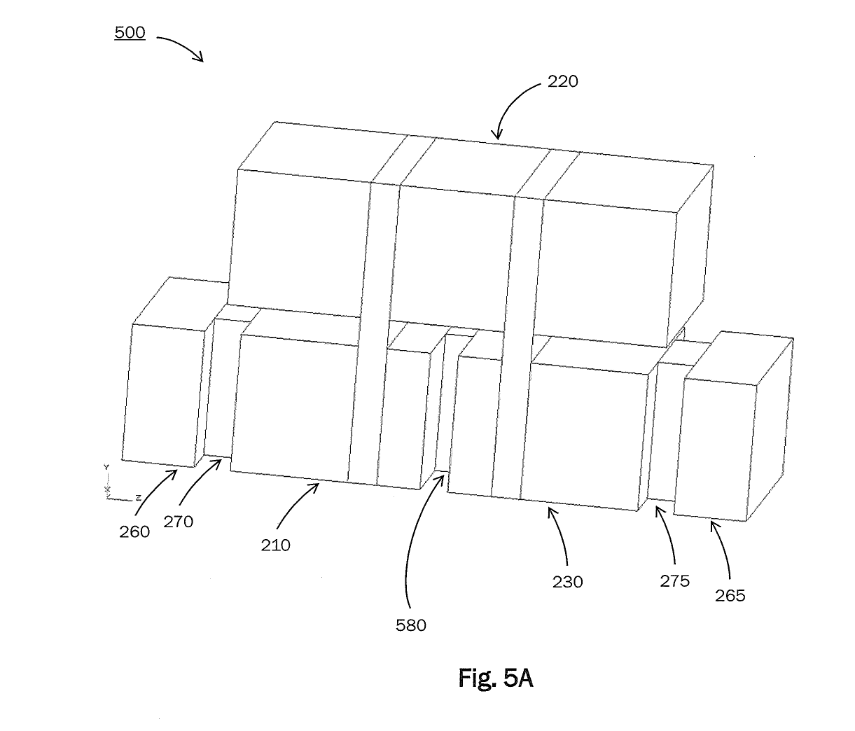

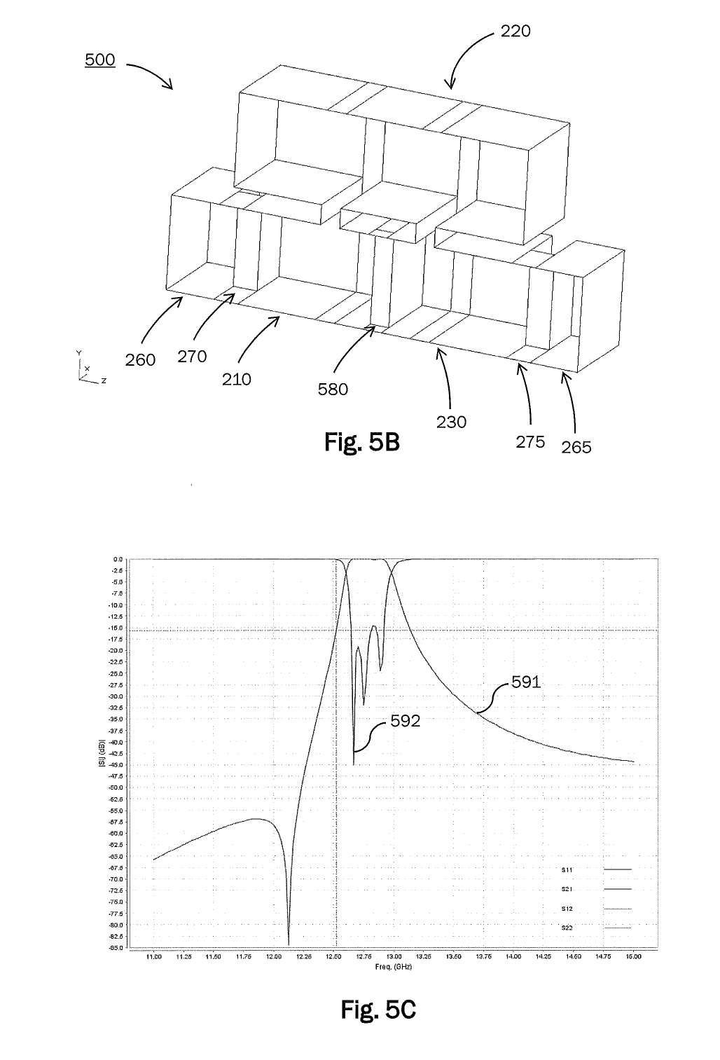

Next, as a further example, a rectangular waveguide filter 500 according to a fifth embodiment of the invention, which is a three pole filter with a transmission zero below the pass-band, will be described with reference to FIGS. 5A to 5C. FIG. 5A is a perspective view of the rectangular waveguide filter 500, FIG. 5B is a sagittal cut through the rectangular waveguide filter 500, and FIG. 5C illustrates the electrical performance of the rectangular waveguide filter 500.

The rectangular waveguide filter 500 according to the fifth embodiment corresponds to the rectangular waveguide filter 200 according to the second embodiment with an additional inductive coupling section 580 interposed between an aperture (coupling aperture) in the one of the end walls 215, 216 of the first resonator 210 and an aperture (coupling aperture) in the one of the end walls 235, 236 of the third resonator 230. Additionally, the first to third resonators 210, 220, 230 are configured such that the resonant mode of the second resonator 220 is the TE102 mode, while the resonant mode of first and third resonators 210, 230, is the TE101 mode. FIGS. 5A and 5B correspond to FIGS. 2A and 2B, so that reference signs indicating the walls of the respective resonators are omitted in FIGS. 5A and 5B.

With the above choice of resonant modes for the first to third resonators 210, 220, 230, a negative sign of the coupling between the first and third resonators 210, 230 is achieved by using a TE012 mode as a second resonance mode, so that the input and output electrical fields (i.e. the electrical fields in the first and third resonators 210, 230) are naturally out of phase, and a transmission zero of the filter below the pass-band is obtained.

FIG. 5C illustrates the electrical performance of the rectangular waveguide filter 500 of FIGS. 5A and 5B. The abscissa indicates the frequency in units of GHz, and the ordinate indicates the S-parameter of the rectangular waveguide filter 500 in units of dB. Graph 591 indicates the S21-component of the S-parameter, and graph 592 indicates the S11-component of the S-parameter. For reasons of symmetry, S11=S22 and S21=S12 hold for the rectangular waveguide filter 500. As can be seen from FIG. 5C, S11 has three poles in the pass-band indicated by S21 (in the figure at about 12.65, 12.75, and 12.9 GHz). Further, S21 has a transmission zero below the pass-band at about 12.1 GHz.

In the rectangular waveguide filters 400, 500 according to the fourth and fifth embodiments of the invention, the transmission zeros above or below the pass-band are implemented by introducing an additional coupling between the first and third resonators 210, 230. The location in frequency of these transmission zeros can be adjusted by changing the coupling between the first resonator 210 and the third resonator 230. Obviously, such a coupling would not be possible for the standard in-line filter structure as illustrated e.g. in FIGS. 14A and 15A.

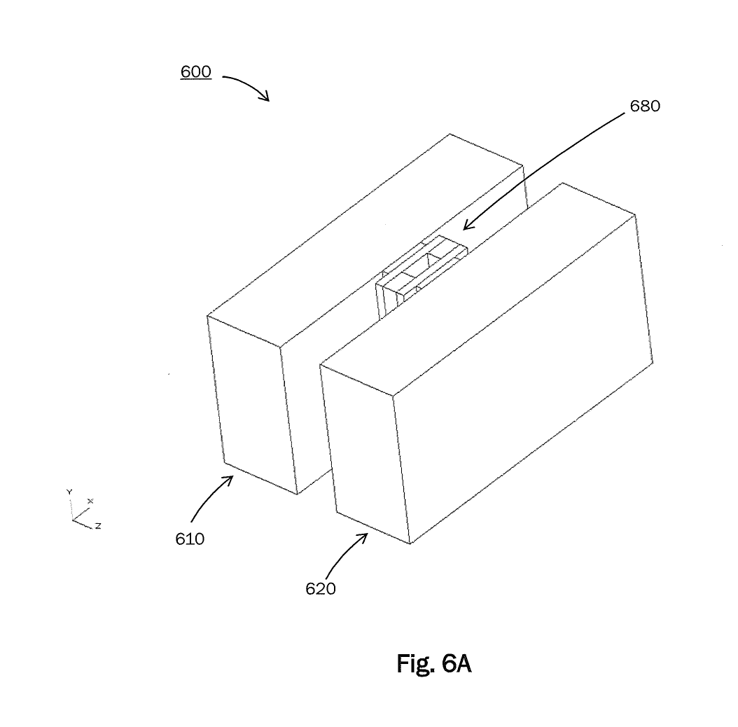

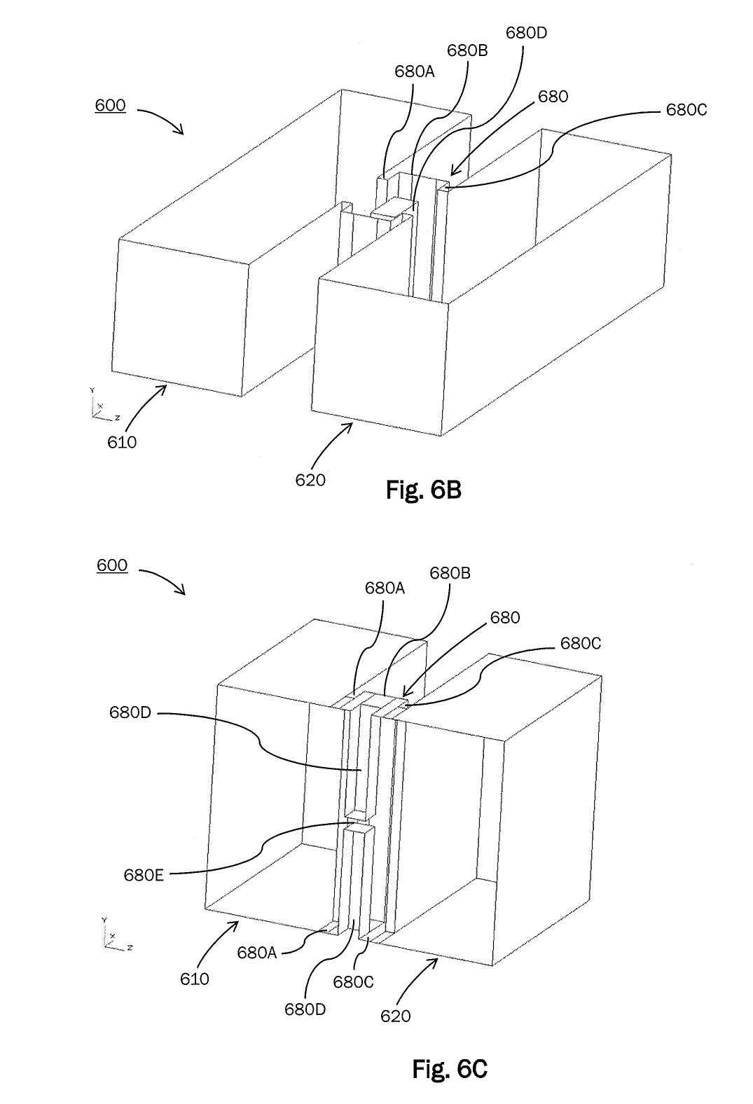

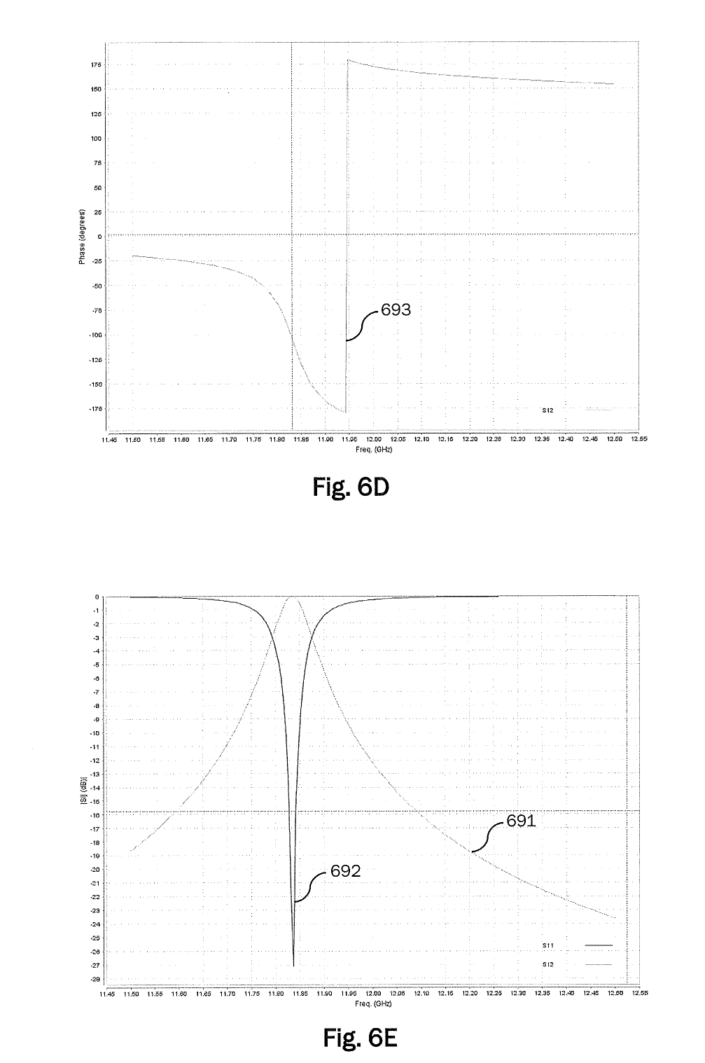

An additional possibility to implement a negative coupling is to use a resonant coupling element, such as a ridge resonator. FIGS. 6A to 6E illustrate a resonator structure 600 comprising a ridge resonator 680 that can be used instead of the hybrid coupling section 480 in the rectangular waveguide filter 400 according to the fourth embodiment, or the inductive coupling section 580 in the rectangular waveguide filter 500 according to the fifth embodiment. FIG. 6A is a perspective view of the resonator structure 600, FIG. 6B is a horizontal cut through the resonator structure 600, FIG. 6C is a sagittal cut through the resonator structure 600, and FIGS. 6D and 6E illustrate the electrical performance of the resonator structure 600.

In FIGS. 6A to 6C, the ridge resonator 680 is interposed between a first resonator 610 and a second resonator 620. The ridge resonator 680 comprises, along its guide direction, a first section 680A, a second section 680B and a third section 680C. The first to third sections 680A, 680B, 680C have identical heights b8A, b8B, b8C. A width a8A of the first section 680A is equal to a width a8C of the third section 680C, whereas a width a8B of the second section 680B is larger than the widths of the first and third sections 680A, 680C, i.e. a8B>a8A=a8C. Inside the second section 680B, a vertical post 680D is provided that extends along the height direction from a bottom wall of the ridge resonator 680 to a top wall of the ridge resonator 680. The post 680D has a gap 680E in its middle section.

FIGS. 6D and 6E illustrate the electrical performance of the resonator structure 600 of FIGS. 6A to 6C. The respective abscissa indicates the frequency in units of GHz, the ordinate in FIG. 6D indicates the phase of the S-parameter of the resonator structure 600 in units of degrees, and the ordinate in FIG. 6E indicates the modulus of the S-Parameter of the resonator structure 600 in units of dB. Graph 691 indicates the modulus of the S12-component of the S-parameter, graph 692 indicates the modulus of the S11-component of the S-parameter, and graph 693 indicates the phase of the S12 -component of the S-parameter. For reasons of symmetry, S11=S22 and S21=S12 hold for the resonator structure 600.

As can be seen from FIG. 6D, the phase of S12 flips sign from negative to positive at the resonant frequency of the ridge resonator 630 at about 11.84 GHz (cf. FIG. 6E). Therefore, if used as a coupling element, the ridge resonator 680 will provide a negative coupling below its resonant frequency, and a positive coupling above its resonant frequency. Although this behavior is indeed well-known, the use of a “de-tuned” ridge resonator as a coupling element has not been reported in the prior art.

Using a ridge coupling structure in the three pole filter of the second embodiment, a transmission zero above or below the pass-band can be easily obtained. Specific embodiments of the present invention relating to filters with more complex transfer functions employing ridge resonators as coupling structures will be described next.

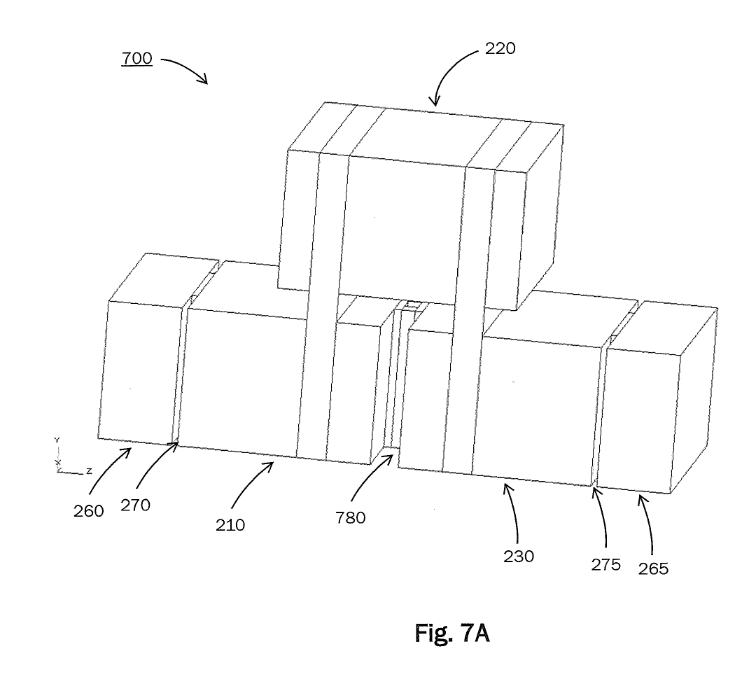

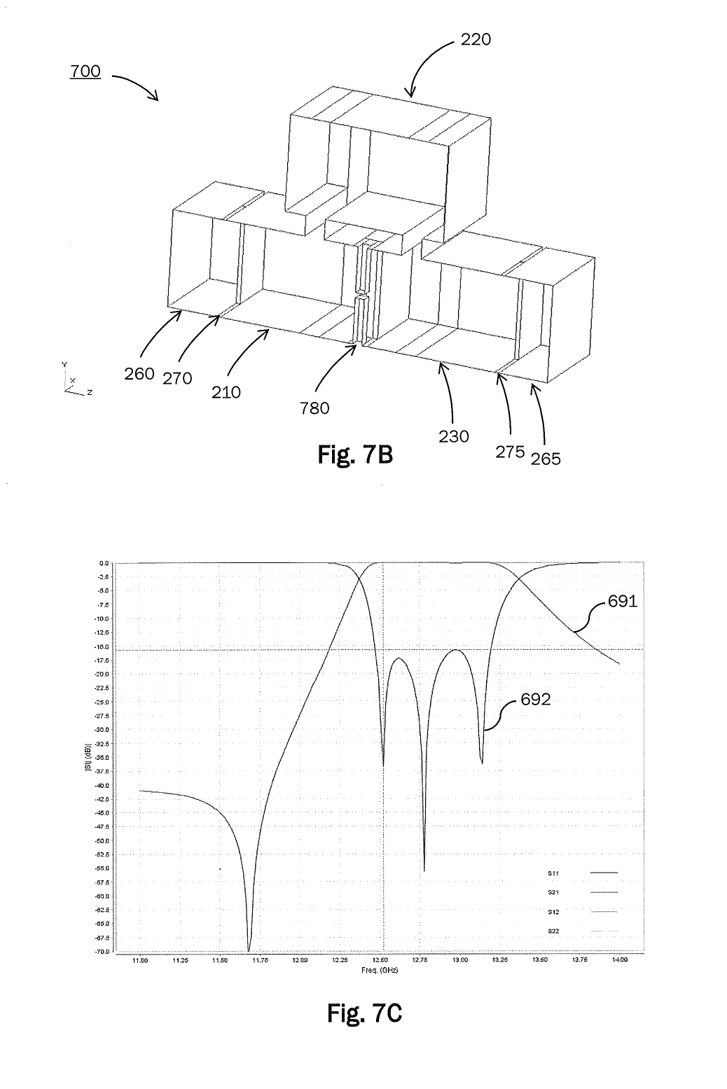

As a first example of such a use of a ridge resonator as a coupling element, a rectangular waveguide filter 700 according to a sixth embodiment of the invention, which is a three pole filter with a transmission zero below the pass-band will be described with reference to FIGS. 7A to 7C. FIG. 7A is a perspective view of the rectangular waveguide filter 700, FIG. 7B is a sagittal cut through the rectangular waveguide filter 700, and FIG. 7C illustrates the electrical performance of the rectangular waveguide filter 700.

The rectangular waveguide filter 700 according to the sixth embodiment corresponds to the rectangular waveguide filter 200 according to the second embodiment with a ridge resonator 780 interposed between an aperture (coupling aperture) in the one of the end walls 215, 216 of the first resonator 210 and an aperture (coupling aperture) in the one of the end walls 235, 236 of the third resonator 230 as a coupling section. FIGS. 7A and 7B correspond to FIGS. 2A and 2B, so that reference signs indicating the walls of the respective resonators are omitted in FIGS. 7A and 7B.

FIG. 7C illustrates the electrical performance of the rectangular waveguide filter 700 of FIGS. 7A and 7B. The abscissa indicates the frequency in units of GHz, and the ordinate indicates the S-parameter of the rectangular waveguide filter 700 in units of dB. Graph 791 indicates the S21-component of the S-parameter, and graph 792 indicates the S11-component of the S-parameter. For reasons of symmetry, S11=S22 and S21=S12 hold for the rectangular waveguide filter 700. As can be seen from FIG. 7C, S11 has three poles in the pass-band indicated by S21 (in the figure at about 12.5, 12.8, and 13.15 GHz). Further, S21 has a transmission zero below the pass-band at about 11.7 GHz.

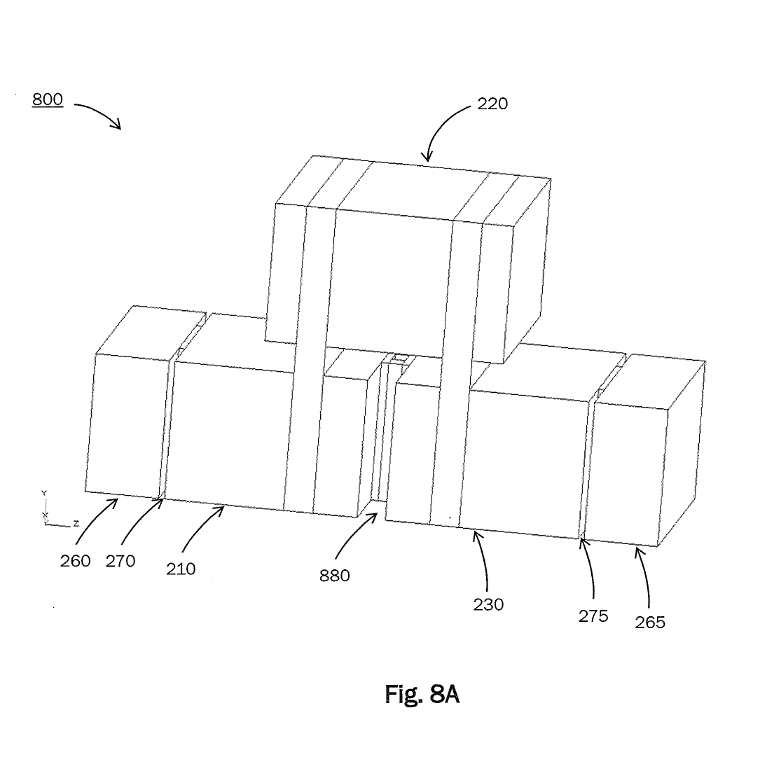

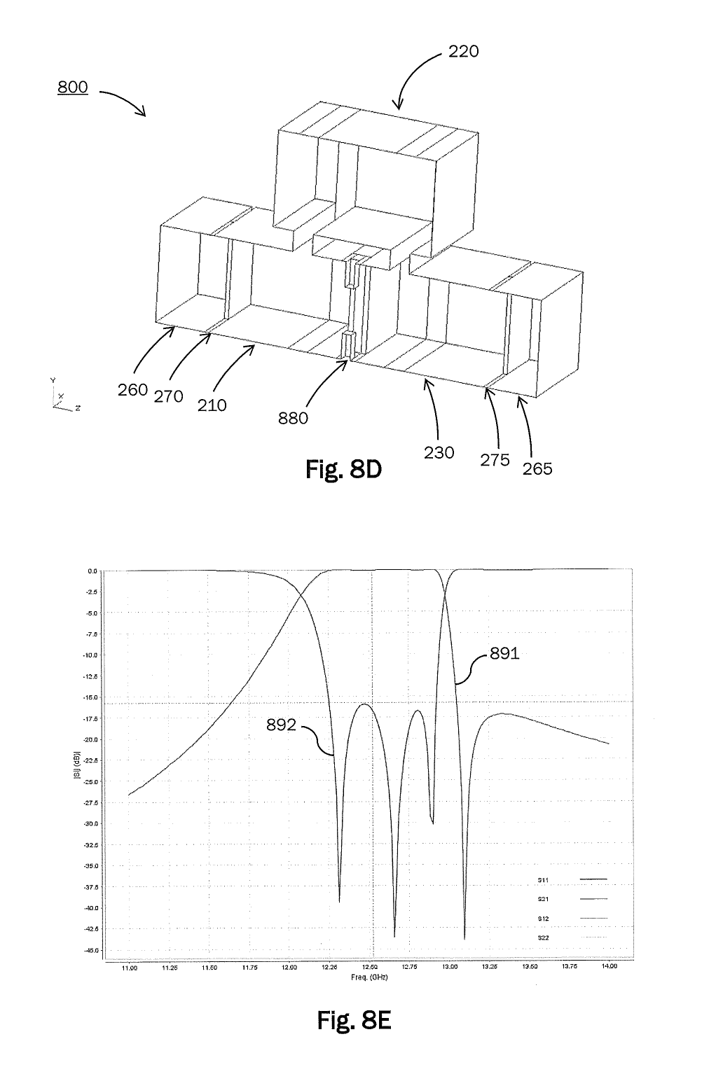

As a second example of the use of a ridge resonator as a coupling element, a rectangular waveguide filter 800 according to a seventh embodiment of the invention, which is a three pole filter with a transmission zero above the pass-band will be described with reference to FIGS. 8A to 8C. FIG. 8A is a perspective view of the rectangular waveguide filter 800, FIG. 8B is a sagittal cut through the rectangular waveguide filter 800, and FIG. 8C illustrates the electrical performance of the rectangular waveguide filter 800.

The rectangular waveguide filter 800 according to the seventh embodiment corresponds to the rectangular waveguide filter 200 according to the second embodiment with a ridge resonator 880 interposed between an aperture (coupling aperture) in the one of the end walls 215, 216 of the first resonator 210 and an aperture (coupling aperture) the one of the end walls 235, 236 of the third resonator 230 as a coupling section. FIGS. 8A and 8B correspond to FIGS. 2A and 2B, so that reference signs indicating the walls of the respective resonators are omitted in FIGS. 8A and 8B.

The rectangular waveguide filter 800 according to the seventh embodiment is different from the rectangular waveguide filter 700 according to the sixth embodiment in that the ridge resonator 880 and the ridge resonator 780 are tuned differently, i.e. they differ in their design parameters and have different resonance frequencies. Design parameters of the ridge resonator are the lengths and width of the first to third sections of the ridge resonator as described with reference to FIGS. 6A to 6C, as well as the width of the post in the second section and the height of the gap in the post. In the sixth embodiment, the ridge resonator 780 is tuned so that its resonance frequency lies above the pass-band of the rectangular waveguide filter 700, whereas in the seventh embodiment, the ridge resonator 880 is tuned so that its resonance frequency lies below the pass-band of the rectangular waveguide filter 800.

FIG. 8C illustrates the electrical performance of the rectangular waveguide filter 800 of FIGS. 8A and 8B. The abscissa indicates the frequency in units of GHz, and the ordinate indicates the S-parameter of the rectangular waveguide filter 800 in units of dB. Graph 891 indicates the S21-component of the S-parameter, and graph 892 indicates the S11-component of the S-parameter. For reasons of symmetry, S11=S22 and S21=S12 hold for the rectangular waveguide filter 800. As can be seen from FIG. 8C, S11 has three poles in the pass-band indicated by S21 (in the figure at about 12.3, 12.65, and 12.9 GHz). Further, S21 has a transmission zero above the pass-band at about 13.1 GHz.

In the sixth and seventh embodiments, a de-tuned ridge resonator has been employed as the coupling structure in the three pole filter of the second embodiment. The de-tuned ridge resonator can also be used to provide a negative coupling between the first and fourth resonators (1-4 coupling) in the four pole filter of the third embodiment, thus producing, at the same time, transmission zeros below and above the pass-band.

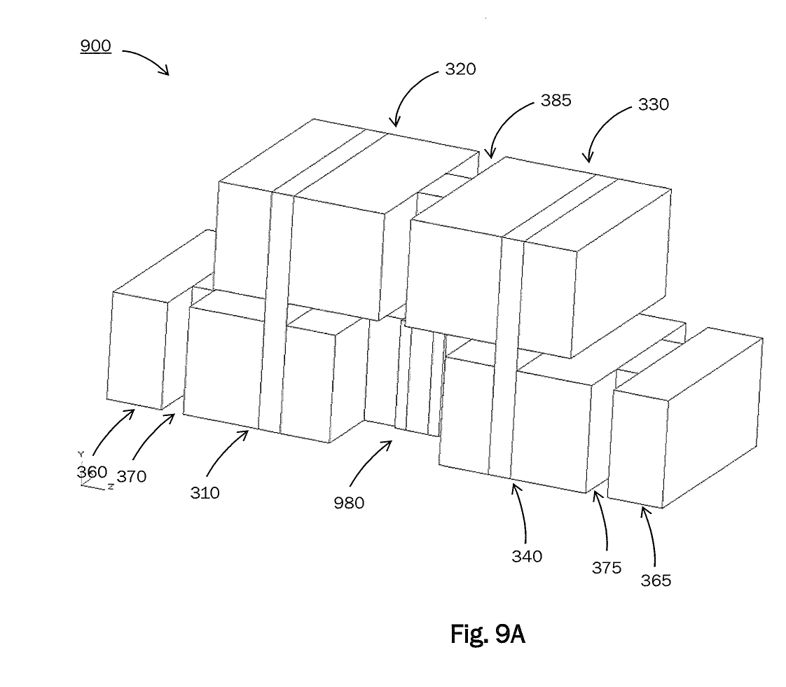

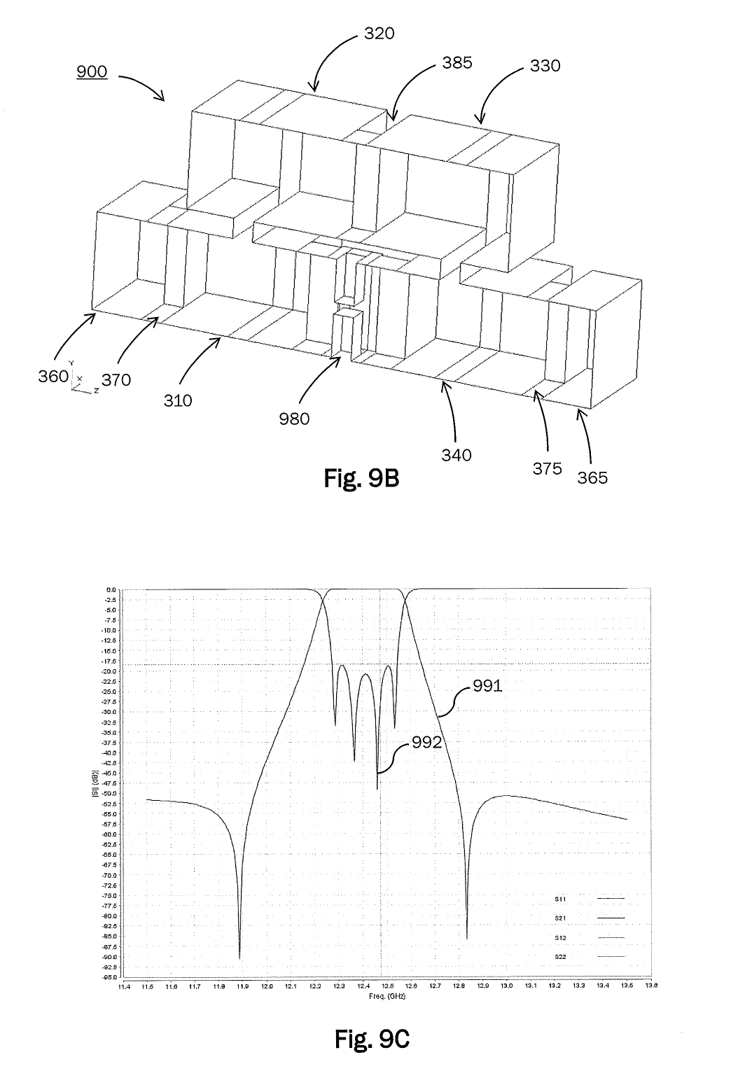

With reference to FIGS. 9A to 9C now a rectangular waveguide filter 900 according to an eighth embodiment of the invention, which is a four pole filter employing a de-tuned ridge resonator 980 as coupling structure will be described. FIG. 9A is a perspective view of the rectangular waveguide filter 900, FIG. 9B is a sagittal cut through the rectangular waveguide filter 900, and FIG. 9C illustrates the electrical performance of the rectangular waveguide filter 900.

The rectangular waveguide filter 900 according to the eighth embodiment corresponds to the rectangular waveguide filter 300 according to the third embodiment with a ridge resonator 980 interposed between an aperture (coupling aperture) the one of the end walls 315, 316 of the first resonator 310 and an aperture (coupling aperture) in the one of end the walls 345, 346 of the fourth resonator 340 as a coupling section. FIGS. 9A and 9B correspond to FIGS. 3A and 3B, so that reference signs indicating the walls of the respective resonators are omitted in FIGS. 9A and 9B.

FIG. 9C illustrates the electrical performance of the rectangular waveguide filter 900 of FIGS. 9A and 9B. The abscissa indicates the frequency in units of GHz, and the ordinate indicates the S-parameter of the rectangular waveguide filter 900 in units of dB. Graph 991 indicates the S21-component of the S-parameter, and graph 992 indicates the S11-component of the S-parameter. For reasons of symmetry, S11=S22 and S21=S12 hold for the rectangular waveguide filter 900. As can be seen from FIG. 9C, S11 has four poles in the pass-band indicated by S21 (in the figure at about 12.29, 13.37, 14.46, and 12.53 GHz). Further, S21 has transmission zeros above and below the pass-band at about 11.88 and 12.83 GHz.

In the eighth embodiment, a de-tuned ridge resonator has been employed as coupling structure in the four pole filter of the third embodiment, thus producing, at the same time, transmission zeros below and above the pass-band. Replacing the de-tuned ridge resonator by an appropriately tuned inductive coupling section (1-4 coupling), a four pole self-equalized bandpass filter can be realized.

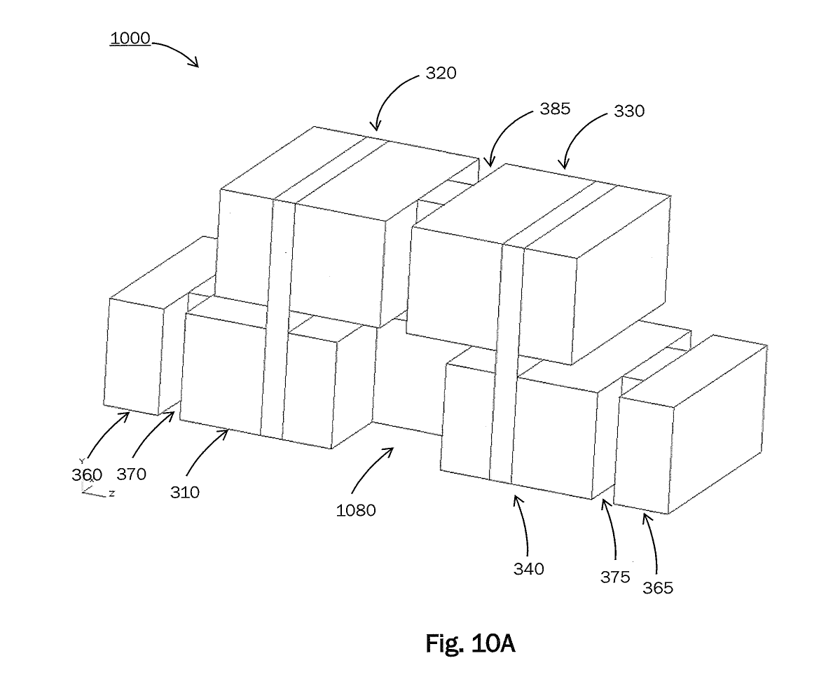

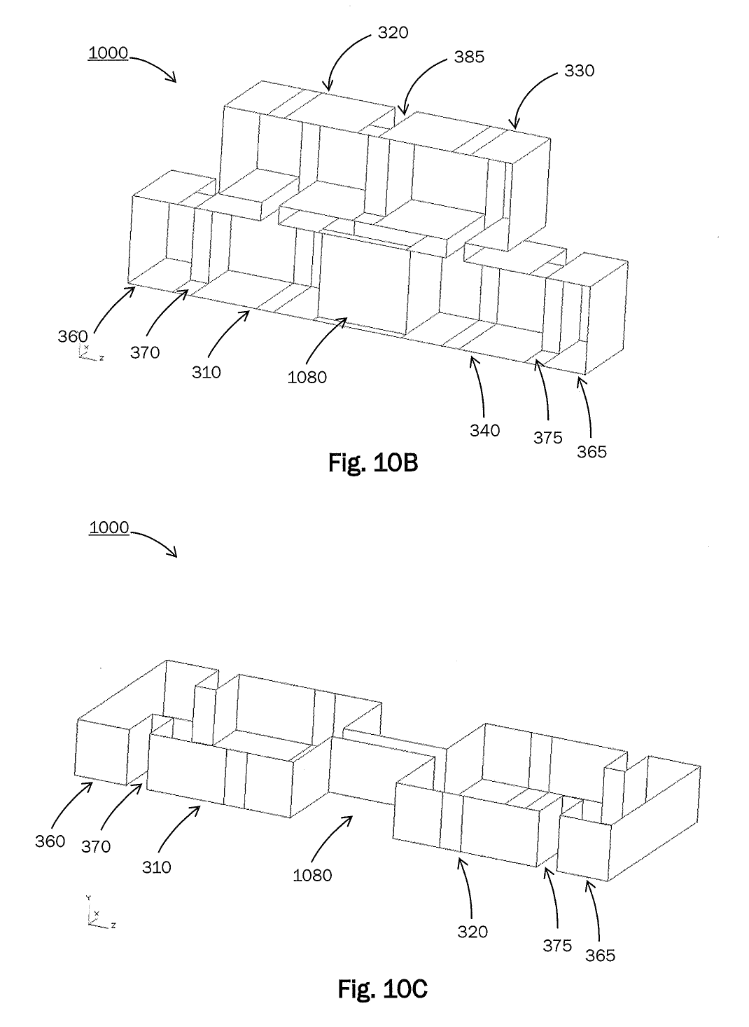

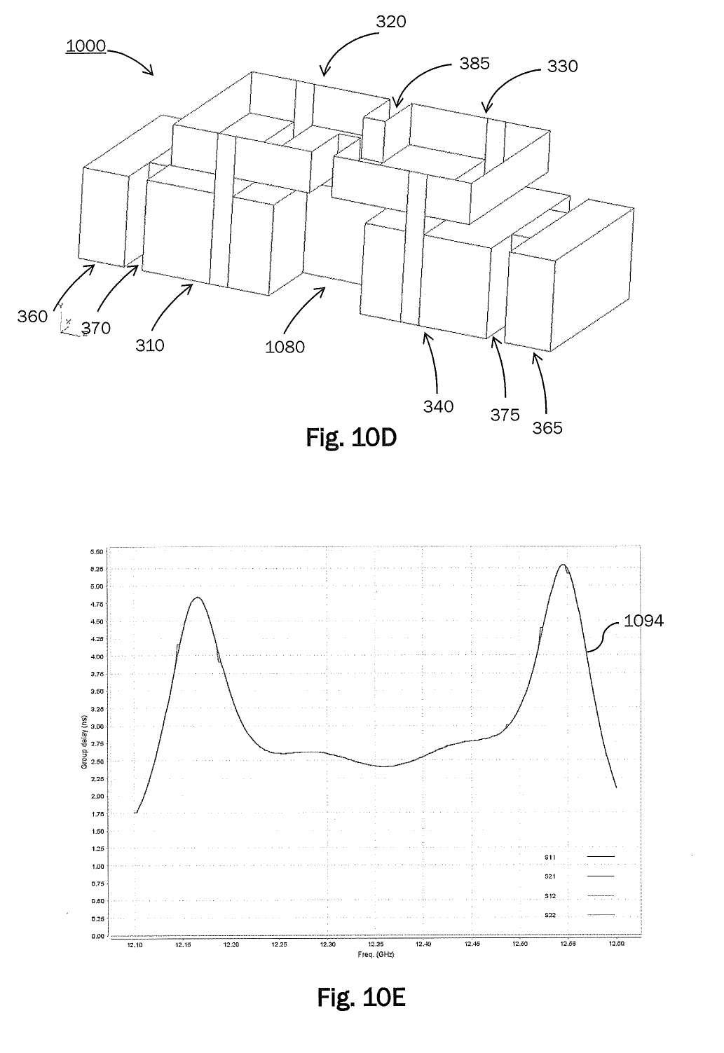

A rectangular waveguide filter 1000 according to a ninth embodiment of the invention, which is a self-equalized four pole filter will now be described with reference to FIGS. 10A to 10E. FIG. 10A is a perspective view of the rectangular waveguide filter 1000, FIG. 10B is a sagittal cut through the rectangular waveguide filter 1000, FIG. 10C is a first horizontal cut through the rectangular waveguide filter 1000, FIG. 10D is a second horizontal cut through the rectangular waveguide filter 1000, and FIG. 10E illustrates the electrical performance of the rectangular waveguide filter 1000.

The rectangular waveguide filter 1000 according to the ninth embodiment corresponds to the rectangular waveguide filter 300 according to the third embodiment with an inductive coupling section 1080 interposed between an aperture (coupling aperture) in the one of the end walls 315, 316 of the first resonator 310 and an aperture (coupling aperture) in the one of the end walls 345, 346 of the fourth resonator 340. FIGS. 10A and 10B correspond to FIGS. 3A and 3B, so that reference signs indicating the walls of the respective resonators are omitted in FIGS. 10A and 10B. Reference signs indicating the walls are also omitted in FIGS. 10C and 10D.

The length of the inductive coupling section 1080 in the guide direction is determined by the arrangement of the first to fourth resonators 310, 320, 330, 340, wherein the shifts in the guide direction between the first and second resonators 310, 320 and between the third and fourth resonators 330, 340, respectively, are design parameters of the rectangular waveguide filter 1000. As can be seen from FIGS. 10B to 10D, wherein FIG. 10C is a horizontal cut through the first and fourth resonators 310, 340 and the inductive coupling section 1080, and FIG. 10D is a horizontal cut through the second and third resonators 320, 330 and the inductive coupling section 385, the width of the inductive coupling section 1080 is smaller than the width of the inductive coupling section 385 between the second and third resonators 320, 330. In particular, the width of the inductive coupling section in the width direction is below cut-off, so that there is no propagation of the base mode of the resonator inside the inductive coupling section 1080. However, since the base mode decays exponentially in the inductive coupling section 1080, there is nevertheless small electromagnetic coupling between the first and fourth resonators 310, 3400 (1-4 coupling), the coupling strength of which depends on the width of the inductive coupling section 1080. By appropriately choosing said width, equalization of the group delay in the rectangular waveguide filter 1000 can be achieved.

FIG. 10E illustrates the electrical performance of the rectangular waveguide filter 1000 of FIGS. 10A to 10D. The abscissa indicates the frequency in units of GHz, and the ordinate indicates the group delay of the S-parameter of the rectangular waveguide filter 1000 in units of nanoseconds (ns). Graph 1094 indicates the group delay of the S12-component of the S-parameter. As can be clearly seen from the graph, the group delay performance shows a typical self-equalized filter performance.

An additional feature of the family of filters according to the present invention is that they allow for the introduction of transmission zeros via an “interference” mechanism that does not require additional cross-couplings. The tenth embodiment described below relates to a two pole structure that introduces a transmission zero above the pass-band, and the eleventh embodiment described below relates to a two pole structure that introduces a transmission zero below the pass-band.

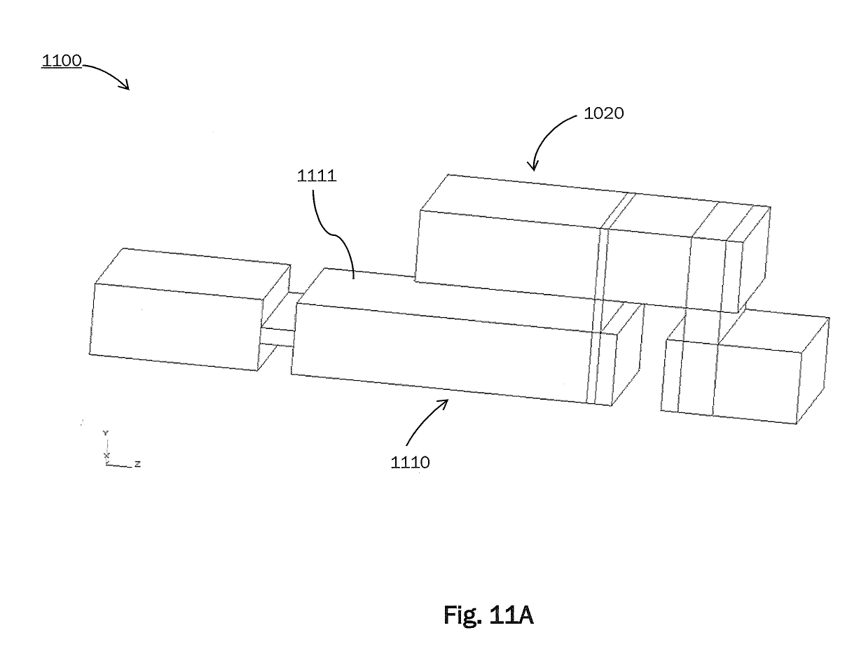

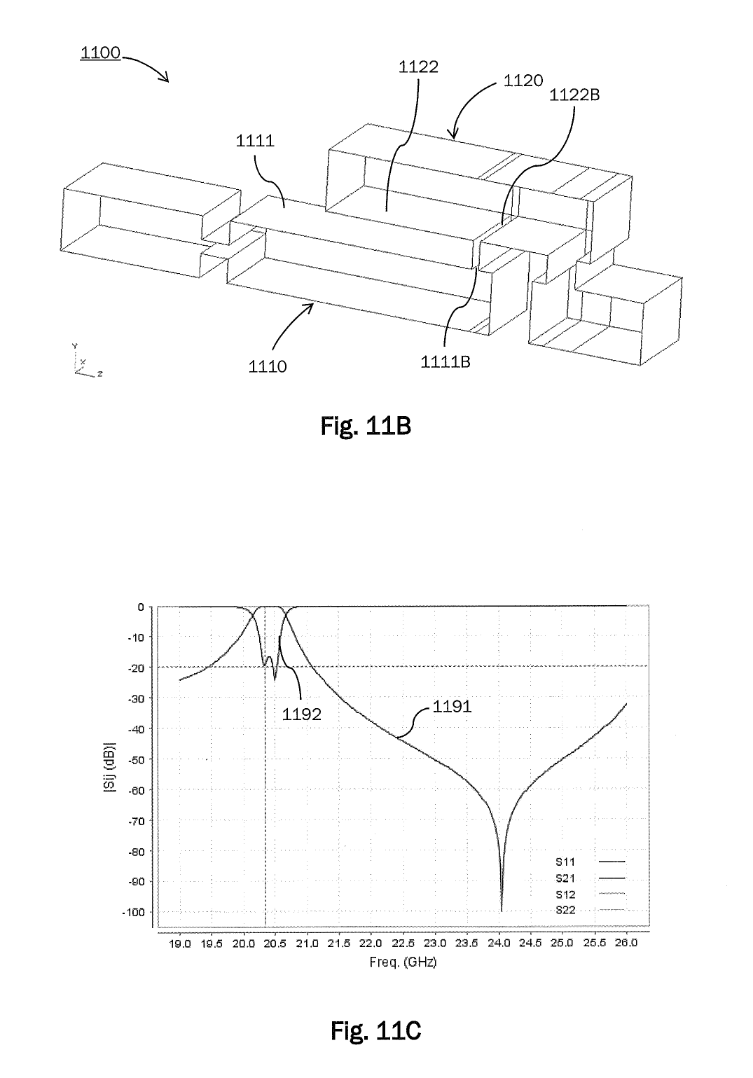

The two pole filter 1100 of the tenth embodiment of the invention will now be described with reference to FIGS. 11A to 11C. FIG. 11A is a perspective view of the rectangular waveguide filter 1100 according to the tenth embodiment, FIG. 11B is a sagittal cut through the rectangular waveguide filter 1100, and FIG. 11C illustrates the electrical performance of the rectangular waveguide filter 1100.

The rectangular waveguide filter 1100 comprises a group of resonators having a first resonator 1110 and a second resonator 1120. Like the first and second resonators 110, 120 in the first embodiment, the first and second resonators 1110, 1120 are coupled to each other through first and second apertures 11118, 1122B (coupling apertures) in their top and bottom walls 1111, 1122, respectively.

FIG. 11C illustrates the electrical performance of the rectangular waveguide filter 1100 of FIGS. 11A and 11B. The abscissa indicates the frequency in units of GHz, and the ordinate indicates the S-parameter of the rectangular waveguide filter 1100 in units of dB. Graph 1191 indicates the S21-component of the S-parameter, and graph 1192 indicates the S11-component of the S-parameter. For reasons of symmetry, S11=S22 and S21=S12 hold for the rectangular waveguide filter 1100. As can be seen from FIG. 11C, S11 has two poles in the pass-band indicated by S21 (in the figure at about 20.3 and 20.5 GHz). Further, S21 has a transmission zero above the pass-band at about 24 GHz.

The interference generating the transmission zero is due to the signal path in the second resonator 1120. More specifically, the signal entering the second resonator 1120 from the second aperture 1122B in the bottom wall 1122 of the second resonator 1120 generates two paths, one to the left and one to the right of the second aperture 1122B. The signal travelling to the left reaches the wall at the end of the second resonator 1120 and is reflected back. When the reflected signal reached the aperture 1122B between the first and the second resonators 1110, 1120, it interferes with the signal traveling to the right and thus creates the transmission zero shown in FIG. 11C above the filter pass-band.

As already mentioned above, the same mechanism can be used to generate a transmission zero below the filter pass-band by increasing the length travelled by the interfering signal.

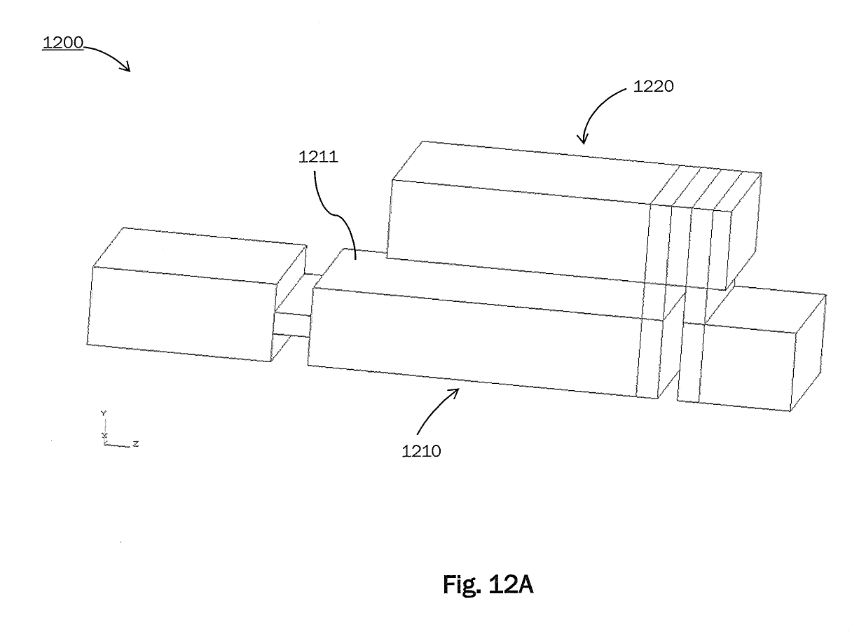

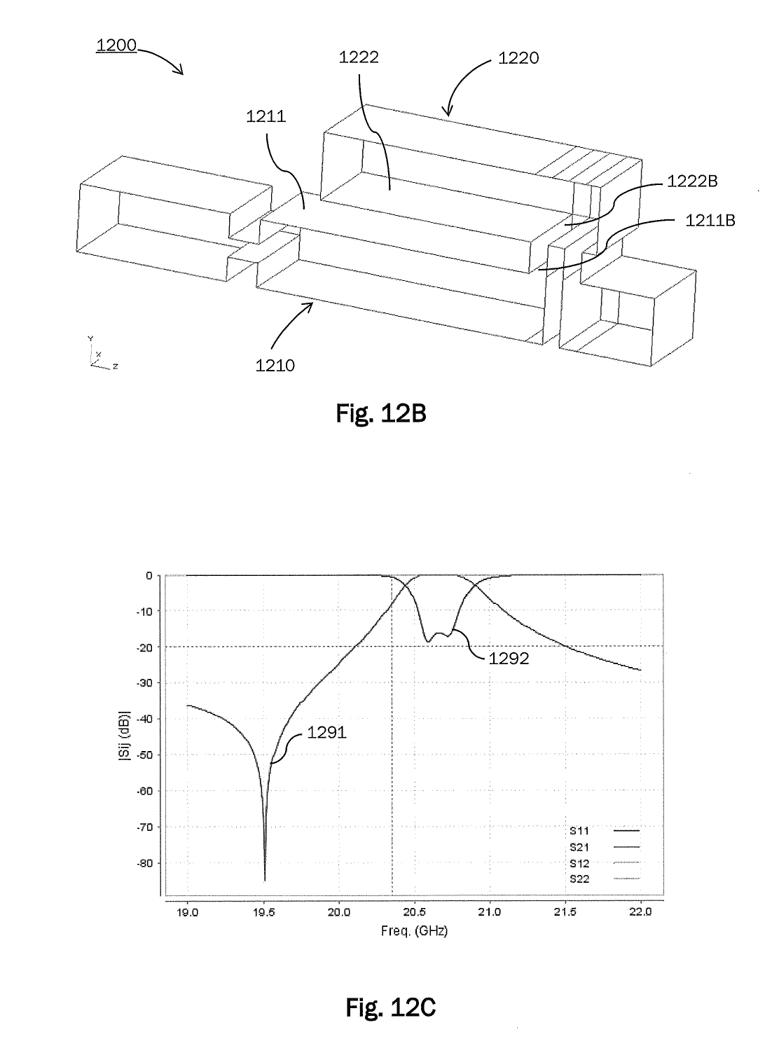

The two pole filter 1200 of the eleventh embodiment of the invention, which has a transmission zero below the pass-band will now be described with reference to FIGS. 12A to 12C. FIG. 12A is a perspective view of the rectangular waveguide filter 1200 according to the eleventh embodiment of the invention, FIG. 12B is a sagittal cut through the rectangular waveguide filter 1200, and FIG. 12C illustrates the electrical performance of the rectangular waveguide filter 1200.

The rectangular waveguide filter 1200 comprises a group of resonators having a first resonator 1210 and a second resonator 1220. Like the first and second resonators 110, 120 in the first embodiment, the first and second resonators 1210, 1220 are coupled to each other through first and second apertures 1211B, 1222B (coupling apertures) in their top and bottom walls 1211, 1222, respectively.

The rectangular waveguide filter 1200 differs from the rectangular waveguide filter 1100 according to the tenth embodiment in that the second aperture 1222B in the bottom wall 1222 of the second resonator 1220 is at a different position along the guide direction of the second resonator 1220. As can be seen from a comparison of FIGS. 11A, 11B, 12A, and 12B, a ratio between a length of the path from the second aperture 1222B to the left and a length of the path from the second aperture 1222B to the right in the eleventh embodiment is larger than the respective ratio in the tenth embodiment. By tuning the value of this ratio, a frequency at which destructive interference as required for the transmission zero occurs, can be shifted.

FIG. 12C illustrates the electrical performance of the rectangular waveguide filter 1200 of FIGS. 12A and 12B. The abscissa indicates the frequency in units of GHz, and the ordinate indicates the S-parameter of the rectangular waveguide filter 1200 in units of dB. Graph 1291 indicates the S21-component of the S-parameter, and graph 1292 indicates the S11-component of the S-parameter. For reasons of symmetry, S11=S22 and S21=S12 hold for the rectangular waveguide filter 1200. As can be seen from FIG. 12C, S11 has two poles in the pass-band indicated by S21 (in the figure at about 20.6 and 20.7 GHz). Further, S21 has a transmission zero below the pass-band at about 19.5 GHz.

Also in this case the interference generating the transmission zero is due to the signal path in the second resonator 1220. More specifically, the signal entering the second resonator 1220 from the aperture 1222B in the bottom wall 1222 of the second resonator 1220 generates two paths, one to the left and one to the right of the aperture 1222B. The signal travelling to the left reaches the wall at the end of the second resonator 1220 and is reflected back. When the reflected signal reaches the aperture 1222B between the first and the second resonators 1210, 1220, it interferes with the signal traveling to the right and thus creates the transmission zero shown in FIG. 12C below the filter pass-band.

Another advantage of the family of filters described in the present disclosure is that a number of similar filter structures can be assembled together very easily in a waveguide manifold configuration, including also more conventional rectangular waveguide filters if necessary, maintaining all the electrical characteristics described above and enabling the low cost clam-shell manufacturing approach for the complete manifold structure. One example of such a manifold configuration is the six channel manifold multiplexer 1300 according to the twelfth embodiment, which is illustrated in FIGS. 13A to 13C. FIG. 13A is a perspective view of the six channel manifold multiplexer 1300, FIG. 13B is a sagittal cut through the six channel manifold multiplexer 1300, and FIG. 13C illustrates the electrical performance of the six channel manifold multiplexer 1300.

The six channel manifold multiplexer 1300 comprises six rectangular waveguide filters 1310 to 1360, one end of each being attached to a central waveguide manifold 1370. An input port of the central waveguide manifold is to the right in FIGS. 13A and 13B, while the left end of the central manifold 1370 is terminated with a short circuit. Six output ports are provided at the respective other ends of the six rectangular waveguide filters 1310 to 1360.

All filters according to the present invention as described above are symmetric with respect to a vertical symmetry plane extending along the guide direction and the height direction of the respective filter (i.e. the y-z-plane). Thus, for all filters according to the present invention, a common approach for manufacturing is to cut the hardware longitudinally in two identical parts. Each individual part can be machined separately and the filter is realized by assembly the two parts. Several different technologies can be used for the actual mechanical realization of the filter parts depending on the required accuracy. If necessary, tuning screws could also be included in the center of the resonators of the respective filters without major difficulties.

Summarizing, the present application invention relates to a new family of rectangular waveguide bandpass filters based on a new resonator geometry referred to by the inventor as Hybrid Folded (HF) rectangular waveguide resonators. The new resonator structure allows for a reduction of filter footprint while providing slightly reduced insertion loss and power performance with respect to standard inductive rectangular waveguide resonator filters. Furthermore, it allows for the implementation of advanced filter transfer functions including both asymmetric and symmetric transmission zero implementations, as well as phase equalization. This new type of filter can be employed in practical applications both in ground and space systems especially for applications above the Ku Band.

Features, components and specific details of the structures of the above-described embodiments may be exchanged or combined to form further embodiments optimized for the respective application. As far as those modifications are readily apparent for an expert skilled in the art, they shall be disclosed implicitly by the above description without specifying explicitly every possible combination, for the sake of conciseness of the present description.

1. A group of rectangular waveguide resonators for use in a rectangular waveguide filter, the group comprising a first resonator and a second resonator,
wherein the first and second resonators are arranged so that first lateral walls of the first resonator extend in parallel to second lateral walls of the second resonator, the first lateral walls corresponding to broad sides of a first cross section of the first resonator perpendicular to a guide direction of the first resonator and the second lateral walls corresponding to broad sides of a second cross section of the second resonator perpendicular to a guide direction of the second resonator;
the first and second resonators are further arranged so that one of the first lateral walls at least partially faces one of the second lateral walls and
the first resonator is electromagnetically coupled to the second resonator through a first aperture in the one of the first lateral walls and a second aperture in the one of the second lateral walls.

2. The group of rectangular waveguide resonators according to claim 1, wherein the first aperture and the second aperture have identical shape and the first and second resonators are further arranged so that the first and second apertures fall in line with each other.

3. The group of rectangular waveguide resonators according to claim 1, wherein
the first aperture has the shape of a rectangle extending over the full width of the first cross section in a width direction of the first resonator, and the second aperture has the shape of a rectangle extending over the full width of the second cross section in a width direction of the second resonator, the width direction of the first resonator being defined by the broad sides of the first cross section, and the width direction of the second resonator being defined by the broad sides of the second cross section.

4. The group of rectangular waveguide resonators according to claim 1, wherein the first and second resonators are further arranged so that
the guide direction of the first resonator extends in parallel to the guide direction of the second resonator;
lateral walls of the first resonator other than the first lateral walls extend in parallel to lateral walls of the second resonator other than the second lateral walls; and
the second resonator is shifted with respect to the first resonator in the guide direction of the first resonator.

5. The group of rectangular waveguide resonators according to claim 1, further comprising a third resonator, wherein
the third resonator is arranged so that a guide direction of the third resonator is aligned with the guide direction of the first resonator and the first cross section is aligned with a third cross section of the third resonator perpendicular to the guide direction of the third resonator; and
the third resonator is electromagnetically coupled to the second resonator.

6. The group of rectangular waveguide resonators according to claim 5, wherein
the third resonator is further arranged so that one of third lateral walls of the third resonator at least partially faces the one of the second lateral walls, the third lateral walls corresponding to broad sides of the third cross section; and
the second resonator is electromagnetically coupled to the third resonator through a third aperture in the one of the second lateral walls, the third aperture being distinct from the second aperture, and a fourth aperture in the one of the third lateral walls.

7. The group of rectangular waveguide resonators according to claim 6, wherein
the first resonator is electromagnetically coupled to the third resonator through opposing apertures in one of end walls of the first resonator and one of end walls of the third resonator.

8. The group of rectangular waveguide resonators according to claim 5, wherein
the first resonator is electromagnetically coupled to the third resonator through a ridge resonator interposed between one of end walls of the first resonator and one of end walls of the third resonator.

9. The group of rectangular waveguide resonators according to claim 5, wherein
the first resonator is electromagnetically coupled to the third resonator through an inductive coupling section interposed between one of end walls of the first resonator and one of end walls the third resonator.

10. The group of rectangular waveguide resonators according to claim 5, wherein
a first electrical length of the first resonator in the guide direction of the first resonator is equal to half of a second electrical length of the second resonator in the guide direction of the second resonator and equal to a third electrical length of the third resonator in the guide direction of the third.

11. The group of rectangular waveguide resonators according to claim 1, further comprising a third resonator and a fourth resonator, wherein
the third resonator is arranged so that a guide direction of the third resonator is aligned with the guide direction of the second resonator, and the second cross section is aligned with a third cross section of the third resonator perpendicular to the guide direction of the third resonator;
the fourth resonator is arranged so that a guide direction of the fourth resonator is aligned with the guide direction of the first resonator and the first cross section is aligned with a fourth cross section of the fourth resonator perpendicular to the guide direction of the fourth resonator;
the third and fourth resonators are further arranged so that third lateral walls of the third resonator extend in parallel to fourth lateral walls of the fourth resonator, the third lateral walls corresponding to broad sides of the third cross section, and the fourth lateral walls corresponding to broad sides of the fourth cross section;
the third and fourth resonators are further arranged so that one of the third lateral walls at least partially faces one of the fourth laterals walls;
the second resonator is electromagnetically coupled to the third resonator through opposing apertures in one of end walls of the second resonator and one of end walls of the third resonator; and
the third resonator is electromagnetically coupled to the fourth resonator through a third aperture in the one of the third lateral walls and a fourth aperture in the one of the fourth lateral walls.

12. The group of rectangular waveguide resonators according to claim 11, wherein
the first resonator is electromagnetically coupled to the fourth resonator through opposing apertures in one of end walls of the first resonator and one of end walls of the fourth resonator.

13. The group of rectangular waveguide resonators according to claim 11, wherein
the first resonator is electromagnetically coupled to the fourth resonator through a ridge resonator interposed between one of end walls of the first resonator and one of end walls the fourth resonator.

14. The group of rectangular waveguide resonators according to claim 11, wherein
the first resonator is electromagnetically coupled to the fourth resonator through an inductive coupling section interposed between one of end walls of the first resonator and one of end walls of the fourth resonator.

15. The group of rectangular waveguide resonators according to claim 1, further comprising a third resonator, wherein
the third resonator is arranged so that third lateral walls of the third resonator extend in parallel to the first lateral walls, the third lateral walls corresponding to broad sides of a third cross section of the third resonator perpendicular to a guide direction of the third resonator;
the third resonator is further arranged so that one of the third lateral walls at least partially faces the other one of the first lateral walls; and
the first resonator is electromagnetically coupled to the third resonator through a third aperture in other one of the first lateral walls and a fourth aperture in the one of the third lateral walls.

16. The group of rectangular waveguide resonators according to claim 1, further comprising a third resonator and a fourth resonator, wherein
the third resonator is arranged so that a guide direction of the third resonator is aligned with the guide direction of the first resonator;
the first resonator is electromagnetically coupled to the third resonator;
the fourth resonator is arranged so that third lateral walls of the third resonator extend in parallel to fourth lateral walls of the fourth resonator, the third lateral walls corresponding to broad sides of a third cross section of the third resonator perpendicular to the guide direction of the third resonator, and the fourth lateral walls corresponding to broad sides of a fourth cross section of the fourth resonator perpendicular to the guide direction of the fourth resonator;
the third and fourth resonators are further arranged so that one of the third lateral walls at least partially faces one of the fourth lateral walls;
the third resonator is electromagnetically coupled to the fourth resonator through a third aperture in the one of the third lateral walls and a fourth aperture in the one of the fourth lateral walls; and
the second resonator and the fourth resonator are arranged on opposite sides of a central axis of the first resonator extending along the guide direction of the first resonator.

17. A rectangular waveguide filter comprising the group of rectangular waveguide resonators according to claim 1.
